(19) United States
(12) Patent Application Publication
(10) Pub. No.: US 2023/0318022 A1
(43) Pub. Date: Oct. 5, 2023

(54) METHODS OF FORMING A SECONDARY BATTERY ASSEMBLY

(71) Applicant: Enovix Corporation, Fremont, CA (US)

(72) Inventors: Aditya MANDALAM, San Jose, CA (US); James MOODY, Alamo, CA (US); Richard J. CONTRERAS, Campbell, CA (US); Kim Han LEE, Pleasanton, CA (US); Robert S. Busacca, Oakland, CA (US); Claire KO, Sunnyvale, CA (US); Anand Mohan YADAV, Santa Clara, CA (US)

(21) Appl. No.: 18/189,404

(22) Filed: Mar. 24, 2023

Related U.S. Application Data
(60) Provisional application No. 63/326,112, filed on Mar. 31, 2022.

(51) Int. Cl. H01M 10/0525; H01M 50/507; H01M 50/105; H01M 10/04; H01M 50/183

(52) U.S. Cl. CPC H01M 10/0525; H01M 50/507; H01M 50/105; H01M 10/0481; H01M 50/183

(57) ABSTRACT

A method comprises positioning a lithium containing secondary battery within a pouch defined by an enclosure, trimming the enclosure to form a plurality of flaps, attaching a first side flap and a second side flap of the plurality of flaps to the pouch by folding each of the first and second side flaps towards and into contact with the pouch, wherein a portion of the first side flap extends beyond the pouch to define a first tab and a portion of the second side flap extends beyond the pouch to define a second tab, attaching an end flap of the plurality of flaps to the pouch by folding the end flap towards and into contact with the pouch, and attaching the first tab and the second tab to the end flap by folding the first and second tabs towards and into contact with the end flap.

### CROSS-REFERENCE TO RELATED APPLICATION

This application claims priority to U.S. Provisional Patent Application No. 63/326,112, filed Mar. 31, 2022, the disclosure of which is hereby incorporated by reference in its entirety.

### FIELD

The field of the disclosure relates generally to the formation of secondary batteries, and more specifically, methods of forming secondary battery assemblies following a pre-lithiation process.

### BACKGROUND

In rocking-chair battery cells, both the positive electrode and the negative electrode of a secondary battery comprise materials into which a carrier ion, such as lithium, inserts and extracts. As the battery is discharged, carrier ions are extracted from the negative electrode and inserted into the positive electrode. As the battery is charged, the carrier ion is extracted from the positive electrode and inserted into the negative electrode.

After a lithium containing secondary battery is assembled, the assembled battery is typically subjected to a formation process. During the formation process, the battery is slowly charged and discharged one or more times. At least some known formation processes include a pre-lithiation process to add lithium to the battery. In some instances, it may be desirable to remove one or more auxiliary electrodes used in the pre-lithiation process to reduce the footprint and increase the energy density of the secondary battery following the pre-lithiation process.

### BRIEF DESCRIPTION

One embodiment comprises a method of forming a lithium containing secondary battery including a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure. The method comprises positioning the lithium containing secondary battery within a pouch defined by an enclosure, trimming the enclosure to form a plurality of flaps, the plurality of flaps including a first side flap extending from the pouch at a first fold line, a second side flap extending from the pouch at a second fold line, and an end flap extending from the pouch at a third fold line, and attaching the first side flap and the second side flap to the pouch by folding each of the first and second side flaps about the respective first and second fold lines towards and into contact with the pouch. A portion of the first side flap extends beyond the pouch to define a first tab and a portion of the second side flap extends beyond the pouch to define a second tab. The method further includes attaching the end flap to the pouch by folding the end flap about the third fold line towards and into contact with the pouch, and attaching the first tab and the second tab to the end flap by folding each of the first tab and the second tab towards and into contact with the end flap.

Another embodiment comprises a method of forming a lithium containing secondary battery positioned within a pouch defined by an enclosure. The lithium containing battery includes a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure. The enclosure includes a plurality of flaps extending outward from the pouch, the plurality of flaps including a first side flap extending from the pouch at a first fold line, a second side flap extending from the pouch at a second fold line, and an end flap extending from the pouch at a third fold line. The method comprises applying a bonding agent to at least one of the first side flap and the pouch, to at least one of the second side flap and the pouch, and to at least one of the end flap and the pouch, folding the first side flap about the first fold line towards the pouch, wherein a portion of the first side flap extends beyond the pouch to define a first tab, folding the second side flap about the second fold line towards the pouch, wherein a portion of the second side flap extends beyond the pouch to define a second tab, compressing the first and second side flaps against the pouch, folding the end flap about the third fold line towards and into contact with the pouch, applying, after the end flap is folded into contact with the pouch, a bonding agent to at least one of the end flap and each of the first and second tabs, folding the first tab and the second tab towards and into contact with the end flap to connect the first and second tabs to the end flap, and compressing the end flap, the first tab, and the second tab against the pouch.

Another embodiment comprises a method of forming a lithium containing secondary battery including a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure. The method comprises positioning the lithium containing secondary battery within a pouch defined by an enclosure, positioning an auxiliary electrode within the pouch such that the auxiliary electrode is in contact with the lithium containing secondary battery, performing a buffer process on the lithium containing secondary battery whereby carrier ions from the auxiliary electrode are transferred to the lithium containing secondary battery, removing the auxiliary electrode from the pouch after the buffer process, sealing the enclosure with the secondary battery positioned within the pouch after the auxiliary electrode is removed from the pouch, trimming the sealed enclosure to form a plurality of flaps in the enclosure, wherein each flap extends outward from the pouch at a respective fold line, the plurality of flaps including a first side flap, a second side flap, and an end flap, attaching the first and second side flaps to the pouch by folding each of the first and second side flaps towards and into contact with the pouch, wherein a portion of the first side flap extends beyond the pouch to define a first tab, and a portion of the second side flap extends beyond the pouch to define a second tab, attaching the end flap to the pouch by folding the end flap towards and into contact with the pouch, and attaching the first tab and the second tab to the end flap by folding each of the first tab and the second tab towards and into contact with the end flap.

Another embodiment comprises a method of forming a lithium containing secondary battery including a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure. The method comprises positioning the lithium containing secondary battery within a pouch defined by an enclosure, where the enclosure includes a first enclosure layer and a second enclosure layer joined to the first enclosure layer, the pouch including a base defined by the first enclosure layer, a cover positioned opposite the base and defined by the second enclosure layer, a first sidewall extending from the base to the cover, a second sidewall positioned opposite the first sidewall and extending from the base to the cover, a first end wall extending from the first sidewall to the second sidewall and from the base to the cover, and a second end wall positioned opposite the first end wall and extending from the first sidewall to the second sidewall and from the base to the cover, wherein the first and second terminals of the secondary battery extend outward from the second end wall. The method further includes trimming the enclosure to form a plurality of flaps in the enclosure, wherein each flap extends outward from the pouch at a respective fold line and includes a first surface defined by the first enclosure layer and an opposing second surface defined by the second enclosure layer, the plurality of flaps including a first side flap extending from the first sidewall of the pouch at a first fold line, a second side flap extending from the second sidewall of the pouch at a second fold line, and an end flap extending from the first end wall of the pouch at a third fold line. The method further includes applying a bonding agent to at least one of the first surface of the first side flap and the pouch first sidewall, to at least one of the first surface of the second side flap and the pouch second sidewall, and to at least one of the first surface of the end flap and the first end wall, folding the first side flap about the first fold line towards and into contact with the pouch first sidewall, wherein a portion of the first side flap extends beyond the pouch first end wall to define a first tab, folding the second side flap about the second fold line towards and into contact with the pouch second sidewall, wherein a portion of the second side flap extends beyond the pouch first end wall to define a second tab, compressing the first side flap against the pouch first sidewall and the second side flap against the pouch second sidewall while heated at a first temperature for a first compression time, folding the end flap about the third fold line towards and into contact with the pouch first end wall, applying, after the end flap is folded into contact with the pouch first end wall, a bonding agent to at least one of the second surface of the end flap and the first surface of each of the first and second tabs, folding the first tab about a fourth fold line towards and into contact with the second surface of the end flap, folding the second tab about a fifth fold line towards and into contact with the second surface of the end flap, and compressing the end flap, the first tab, and the second tab against the pouch first end wall while heated at a second temperature for a second compression time.

Various refinements exist of the features noted in relation to the above-mentioned aspects. Further features may also be incorporated in the above-mentioned aspects. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a perspective view of a secondary battery of an exemplary embodiment.

FIG. 2 depicts a unit cell for the secondary battery of FIG. 1.

FIG. 3 depicts an example cathode structure for the unit cell of FIG. 2.

FIG. 4 depicts an anode structure for the unit cell of FIG. 2.

FIG. 5 depicts a perspective view of a buffer system of an exemplary embodiment.

FIG. 6 depicts an exploded view of the buffer system of FIG. 5.

FIG. 7 depicts a perspective view of an auxiliary electrode of an exemplary embodiment.

FIG. 8 depicts an exploded view of the auxiliary electrode of FIG. 7.

FIG. 9 is a perspective view of the auxiliary electrode of FIG. 7 at a stage in an assembly process for the auxiliary electrode of FIG. 7.

FIG. 10 is a perspective view of the auxiliary electrode of FIG. 7 at another stage in an assembly process for the auxiliary electrode of FIG. 7.

FIG. 11 is a perspective view of the auxiliary electrode of FIG. 7 at yet another stage in an assembly process that adds an extension tab to the auxiliary electrode of FIG. 7.

FIG. 12 is a perspective view of the buffer system of FIG. 5 at a stage in an assembly process for the buffer system.

FIG. 13 is a perspective view of the buffer system of FIG. 5 at another stage in an assembly process for the buffer system.

FIG. 14 is a perspective view of the buffer system of FIG. 5 at yet another stage in an assembly process for the buffer system.

FIG. 15 is a cross-sectional view of a portion of the buffer system of FIG. 14.

FIG. 16 is a perspective view of the buffer system of FIG. 5 at yet another stage in an assembly process for the buffer system.

FIG. 17 is a perspective view of the buffer system of FIG. 5 subsequent to performing a buffer process on a secondary battery.

FIG. 18 is a flow chart of a method of pre-lithiating a secondary battery with carrier ions using an auxiliary electrode of an exemplary embodiment.

FIG. 19 is a flow chart depicting additional details of the method of FIG. 18.

FIG. 20 is a flow chart depicting additional details of the method of FIG. 18.

FIG. 21 is a flow chart depicting additional details of the method of FIG. 18.

FIG. 22 is a flow chart of an example method of forming a secondary battery assembly, for example, to prepare the secondary battery assembly for end use following a pre-lithiation or buffer process.

FIG. 23 is a front perspective view of an example secondary battery assembly at an intermediate stage of formation.

FIG. 24 is a rear perspective view of the secondary battery assembly of FIG. 23.

FIG. 25 is another front perspective view of the secondary battery assembly of FIG. 23.

FIGS. 26-31 illustrate steps in an exemplary method of forming the secondary battery assembly of FIG. 23.

### DEFINITIONS

“A,” “an,” and “the” (i.e., singular forms) as used herein refer to plural referents unless the context clearly dictates otherwise. For example, in one instance, reference to “an electrode” includes both a single electrode and a plurality of similar electrodes.

“About” and “approximately” as used herein refers to plus or minus 10%, 5%, or 1% of the value stated. For example, in one instance, about 250 micrometers (μm) would include 225 μm to 275 μm. By way of further example, in one instance, about 1,000 μm would include 900 μm to 1,100 μm. Unless otherwise indicated, all numbers expressing quantities (e.g., measurements, and the like) and so forth used in the specification and claims are to be understood as being modified in all instances by the term “about.” Accordingly, unless indicated to the contrary, the numerical parameters set forth in the following specification and attached claims are approximations. Each numerical parameter should at least be construed in light of the number of reported significant digits and by applying ordinary rounding techniques.

“Anode” as used herein in the context of a secondary battery refers to the negative electrode in the secondary battery.

“Anode material” or “Anodically active” as used herein means material suitable for use as the negative electrode of a secondary battery

“Cathode” as used herein in the context of a secondary battery refers to the positive electrode in the secondary battery

“Cathode material” or “Cathodically active” as used herein means material suitable for use as the positive electrode of a secondary battery.

“Conversion chemistry active material” or “Conversion chemistry material” refers to a material that undergoes a chemical reaction during the charging and discharging cycles of a secondary battery.

“Counter-electrode” as used herein may refer to the negative or positive electrode (anode or cathode), opposite of the Electrode, of a secondary battery unless the context clearly indicates otherwise.

“Counter-electrode current collector” as used herein may refer to the negative or positive (anode or cathode) current collector, opposite of the Electrode current connector, of a secondary battery unless the context clearly indicates otherwise.

“Cycle” as used herein in the context of cycling of a secondary battery between charged and discharged states refers to charging and/or discharging a battery to move the battery in a cycle from a first state that is either a charged or discharged state, to a second state that is the opposite of the first state (i.e., a charged state if the first state was discharged, or a discharged state if the first state was charged), and then moving the battery back to the first state to complete the cycle. For example, a single cycle of the secondary battery between charged and discharged states can include, as in a charge cycle, charging the battery from a discharged state to a charged state, and then discharging back to the discharged state, to complete the cycle. The single cycle can also include, as in a discharge cycle, discharging the battery from the charged state to the discharged state, and then charging back to a charged state, to complete the cycle.

“Electrochemically active material” as used herein means anodically active or cathodically active material.

“Electrode” as used herein may refer to the negative or positive electrode (anode or cathode) of a secondary battery unless the context clearly indicates otherwise.

“Electrode current collector” as used herein may refer to the negative or positive (anode or cathode) current collector of a secondary battery unless the context clearly indicates otherwise.

“Electrode material” as used herein may refer to anode material or cathode material unless the context clearly indicates otherwise.

“Electrode structure” as used herein may refer to an anode structure (e.g., negative electrode structure) or a cathode structure (e.g., positive electrode structure) adapted for use in a battery unless the context clearly indicates otherwise.

“Capacity” or “C” as used herein refers to an amount of electric charge that a battery (or a sub-portion of a battery comprising one or more pairs of electrode structures and counter-electrode structures that form a bilayer) can deliver at a pre-defined voltage unless the context clearly indicates otherwise.

“Electrolyte” as used herein refers to a non-metallic liquid, gel, or solid material in which current is carried by the movement of ions adapted for use in a battery unless the context clearly indicates otherwise.

“Charged state” as used herein in the context of the state of a secondary battery refers to a state where the secondary battery is charged to at least 75% of its rated capacity unless the context clearly indicates otherwise. For example, the battery may be charged to at least 80% of its rated capacity, at least 90% of its rated capacity, and even at least 95% of its rated capacity, such as 100% of its rated capacity.

“Discharge capacity” as used herein in connection with a negative electrode means the quantity of carrier ions available for extraction from the negative electrode and insertion into the positive electrode during a discharge operation of the battery between a predetermined set of cell end of charge and end of discharge voltage limits unless the context clearly indicates otherwise.

“Discharged state” as used herein in the context of the state of a secondary battery refers to a state where the secondary battery is discharged to less than 25% of its rated capacity unless the context clearly indicates otherwise. For example, the battery may be discharged to less than 20% of its rated capacity, such as less than 10% of its rated capacity, and even less than 5% of its rated capacity, such as 0% of its rated capacity.

“Reversible coulombic capacity” as used herein in connection with an electrode (i.e., a positive electrode, a negative electrode or an auxiliary electrode) means the total capacity of the electrode for carrier ions available for reversible exchange with a counter electrode.

“Longitudinal axis,” “transverse axis,” and “vertical axis,” as used herein refer to mutually perpendicular axes (i.e., each are orthogonal to one another). For example, the “longitudinal axis,” “transverse axis,” and the “vertical axis” as used herein are akin to a Cartesian coordinate system used to define three-dimensional aspects or orientations. As such, the descriptions of elements of the disclosed subject matter herein are not limited to the particular axis or axes used to describe three-dimensional orientations of the elements. Alternatively stated, the axes may be interchangeable when referring to three-dimensional aspects of the disclosed subject matter.

“Composite material” or “Composite” as used herein refers to a material which comprises two or more constituent materials unless the context clearly indicates otherwise.

“Void fraction” or “Porosity” or “Void volume fraction” as used herein refers to a measurement of the voids (i.e., empty) spaces in a material, and is a fraction of the volume of voids over the total volume of the material, between 0 and 1, or as a percentage between 0% and 100%.

“Polymer” as used herein may refer to a substance or material consisting of repeating subunits of macromolecules unless the context clearly indicates otherwise.

“Microstructure” as used herein may refer to the structure of a surface of a material revealed by an optical microscope above about 25× magnification unless the context clearly indicates otherwise.

“Microporous” as used herein may refer to a material containing pores with diameters less than about 2 nanometers unless the context clearly indicates otherwise.

“Macroporous” as used herein may refer to a material containing pores with diameters greater than about 50 nanometers unless the context clearly indicates otherwise.

“Nanoscale” or “Nanoscopic scale” as used herein may refer to structures with a length scale in the range of about 1 nanometer to about 100 nanometers.

“Pre-lithiation” or “Pre-lithiate” as used herein may refer to the addition of lithium to the active lithium content of a lithium containing secondary battery as part of the formation process prior to battery operation to compensate for the loss of active lithium. “Pre-lithiation” or “Pre-lithiate” may also be referred to herein as a “buffer process.”

### DETAILED DESCRIPTION

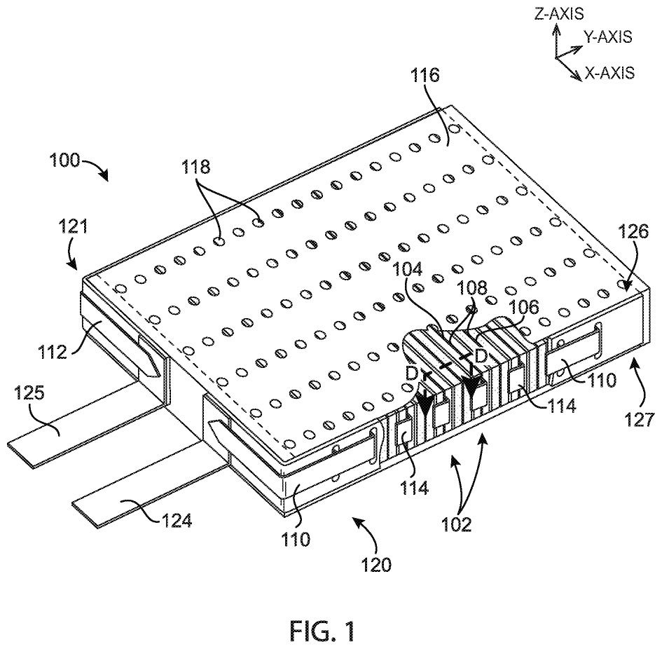

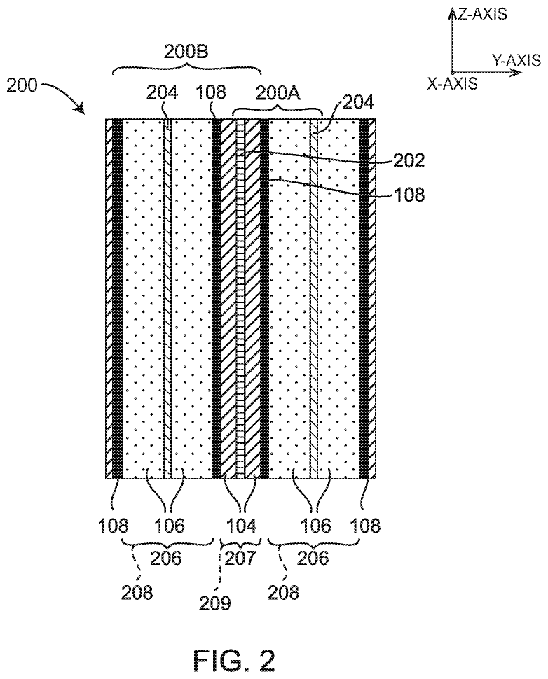

FIG. 1 is a perspective view of a secondary battery 100 of an exemplary embodiment, and FIG. 2 depicts a unit cell 200 for the secondary battery 100. The secondary battery 100 in FIG. 1 has a portion exposed showing some of the internal structures of the secondary battery, as further described below.

As illustrated in FIG. 1, the secondary battery 100 includes a plurality of adjacent electrode sub-units 102. Each of the electrode sub-units 102 has a dimension in the X-axis, Y-axis and Z-axis, respectively. The X-axis, Y-axis and Z-axis are each mutually perpendicular, akin to a Cartesian coordinate system. As used herein, dimensions of each electrode sub-unit 102 in the Z-axis may be referred to as a “height”, dimensions in the X-axis may be referred to as a “length” and dimensions in the Y-axis may be referred to as a “width.” The electrode sub-units 102 may be combined into one or more unit cells 200 (see FIG. 2). Each of the unit cells 200 comprises at least one anodically active material layer 104 and at least one cathodically active material layer 106. The anodically active material layer 104 and the cathodically active material layer 106 are electrically isolated from each other by a separator layer 108. It should be appreciated that in suitable embodiments of the present disclosure, any number of the electrode sub-units 102 may be used, such as from 1 to 200 or more of the electrode sub-units 102 in the secondary battery 100.

Referring to FIG. 1, the secondary battery 100 includes a first busbar 110 and a second busbar 112 that are in electrical contact with the anodically active material layer 104 and the cathodically active material layer 106 of each of the electrode sub-units 102, respectively, via electrode tabs 114. The electrode tabs 114 are only visible on a first side 120 of the secondary battery 100 in FIG. 1, although a different set of the electrode tabs 114 are present on a second side 121 of the secondary battery. The electrode tabs 114 on the first side 120 of the secondary battery 100 are electrically coupled with the first busbar 110, which may be referred to as an anode busbar. The electrode tabs 114 on the second side 121 of the secondary battery 100 (not visible in FIG. 1) are electrically coupled to the second busbar 112, which may be referred to as a cathode busbar. In this embodiment, the first busbar 110 is electrically coupled with a first electrical terminal 124 of the secondary battery 100, which is electrically conductive. When the first busbar 110 comprises an anode busbar for the secondary battery 100, the first electrical terminal 124 comprises a negative terminal for the secondary battery 100. Further in this embodiment, the second busbar 112 is electrically coupled with a second electrical terminal 125 of the secondary battery 100, which is electrically conductive. When the second busbar 112 comprises a cathode busbar for the secondary battery 100, the second electrical terminal 125 comprises a positive terminal for the secondary battery 100.

In one embodiment, a casing 116, which may be referred to as a constraint, may be applied over one or both of the X-Y surfaces of the secondary battery 100. In the embodiment shown in FIG. 1, the casing 116 includes a plurality of perforations 118 to facilitate distribution or flow of an electrolyte solution once the secondary battery 100 has been fully assembled. In one embodiment, the casing 116 comprises stainless steel, such as SS301, SS316, 440C or 440C hard. In other embodiments, the casing 116 comprises aluminum (e.g., aluminum 7075-T6, hard H18, etc.), titanium (e.g., 6Al-4V), beryllium, beryllium copper (hard), copper (O₂ free, hard), nickel, other metals or metal alloys, composite, polymer, ceramic (e.g., alumina (e.g., sintered or Coorstek AD96), zirconia (e.g., Coorstek YZTP), yttriastabilizedzirconia (e.g., ENrG E-Strate®)), glass, tempered glass, polyetheretherketone (PEEK) (e.g., Aptiv 1102), PEEK with carbon (e.g., Victrex 90HMF40 or Xycomp 1000-04), polyphenylene sulfide (PPS) with carbon (e.g., Tepex Dynalite 207), polyetheretherketone (PEEK) with 30% glass (e.g., Victrex 90HMF40 or Xycomp 1000-04), polyimide (e.g., Kapton®), E Glass Std Fabric/Epoxy, 0 deg, E Glass UD/Epoxy, 0 deg, Kevlar Std Fabric/Epoxy, 0 deg, Kevlar UD/Epoxy, 0 deg, Carbon Std Fabric/Epoxy, 0 deg, Carbon UD/Epoxy, 0 deg, Toyobo Zylon® HM Fiber/Epoxy, Kevlar 49 Aramid Fiber, S Glass Fibers, Carbon Fibers, Vectran UM LCP Fibers, Dyneema, Zylon, or other suitable material.

In some embodiments, the casing 116 comprises a sheet having a thickness in the range of about 10 to about 100 micrometers (μm). In one embodiment, the casing 116 comprises a stainless-steel sheet (e.g., SS316) having a thickness of about 30 μm. In another embodiment, the casing 116 comprises an aluminum sheet (e.g., 7075-T6) having a thickness of about 40 μm. In another embodiment, the casing 116 comprises a zirconia sheet (e.g., Coorstek YZTP) having a thickness of about 30 μm. In another embodiment, the casing 116 comprises an E Glass UD/Epoxy 0 deg sheet having a thickness of about 75 μm. In another embodiment, the casing 116 comprises 12 μm carbon fibers at >50% packing density.

In this embodiment, the secondary battery 100 includes a first major surface 126 and a second major surface 127 that opposes the first major surface 126. The major surfaces 126, 127 of the secondary battery 100 may be substantially planar is some embodiments.

With reference to FIG. 2, which depicts the secondary battery 100 along cut lines D-D in FIG. 1, the individual layers of the unit cell 200, which may be the same as or similar to the electrode sub-units 102, is shown. For each of the unit cells 200, in some embodiments, the separator layer 108 is an ionically permeable microporous polymeric material suitable for use as a separator in a secondary battery. In an embodiment, the separator layer 108 is coated with ceramic particles on one or both sides. In this embodiment, unit cell 200 includes an anode current collector 202 in the center, which may comprise or be electrically coupled with, one of the electrode tabs 114 on one of the sides 120, 121 of the secondary battery 100 (see FIG. 1). The unit cell 200 further includes the anodically active material layer 104, the separator layer 108, the cathodically active material layer 106, and a cathode current collector 204 in a stacked formation. The cathode current collector 204 may comprise or be electrically coupled with, one of the electrode tabs 114 on one of the sides 120, 121 of the secondary battery 100 that is different than the anode current collector 202.

In an alternative embodiment, the placement of the cathodically active material layer 106 and the anodically active material layer 104 may be swapped, such that the cathodically active material layers are toward the center and the anodically active material layers are distal to the cathodically active material layers. In one embodiment, a unit cell 200A includes, from left to right in stacked succession, the anode current collector 202, the anodically active material layer 104, the separator layer 108, the cathodically active material layer 106, and the cathode current collector 204. In an alternative embodiment, a unit cell 200B includes, from left to right in stacked succession, the separator layer 108, a first layer of the cathodically active material layer 106, the cathode current collector 204, a second layer of the cathodically active material layer 106, the separator layer 108, a first layer of the anodically active material layer 104, the anode current collector 202, a second layer of the anodically active material layer 104, and the separator layer 108.

In FIG. 2, the layered structure comprising the cathodically active material layer 106 and the cathode current collector 204 may be referred to as a cathode structure 206, while the layered structure comprising the anodically active material layer 104 and the anode current collector 202 may be referred to as an anode structure 207. Collectively, the population of the cathode structures 206 for the secondary battery 100 may be referred to as a positive electrode 208 of the secondary battery 100, and the population of the anode structures 207 for the secondary battery 100 (only one of the anode structures 207 are shown in FIG. 2) may be referred to as the negative electrode 209 of the secondary battery 100.

A voltage difference V exists between adjacent cathode structures 206 and anode structures 207, with the adjacent structures considered a bilayer in some embodiments. Each bilayer has a capacity C determined by the makeup and configuration of the cathode structures 206 and the anode structures 207. In this embodiment, each bilayer produces a voltage difference of about 4.35 volts. In other embodiments, each bilayer has a voltage difference of about 0.5 volts, about 1.0 volts, about 1.5 volts, about 2.0 volts, about 2.5 volts, about 3.0 volts, about 3.5 volts, about 4.0 volts, 4.5 volts, about 5.0 volts, between 4 and 5 volts, or any other suitable voltage. During cycling between a charged state and a discharged state, the voltage may vary, for example, between about 2.5 volts and about 4.35 volts. The capacity C of a bilayer in this embodiment is about 3.5 milliampere-hour (mAh). In other embodiments, the capacity C of a bilayer is about 2 mAh, less than 5 mAh, or any other suitable capacity. In some embodiments, the capacity C of a bilayer may be up to about 10 mAh.

The cathode current collector 204 may comprise aluminum, nickel, cobalt, titanium, and tungsten, or alloys thereof, or any other material suitable for use as a cathode current collector layer. In general, the cathode current collector 204 will have an electrical conductivity of at least about 10³ Siemens/cm. For example, in one such embodiment, the cathode current collector 204 will have a conductivity of at least about 10⁴ Siemens/cm. By way of further example, in one such embodiment, the cathode current collector 204 will have a conductivity of at least about 10⁵ Siemens/cm. In general, the cathode current collector 204, may comprise a metal such as aluminum, carbon, chromium, gold, nickel, NiP, palladium, platinum, rhodium, ruthenium, an alloy of silicon and nickel, titanium, or a combination thereof (see “Current collectors for positive electrodes of lithium-based batteries” by A. H. Whitehead and M. Schreiber, Journal of the Electrochemical Society, 152(11) A2105-A2113 (2005)). By way of further example, in one embodiment, the cathode current collector 204 comprises gold or an alloy thereof such as gold silicide. By way of further example, in one embodiment, the cathode current collector 204 comprise nickel or an alloy thereof such as nickel silicide.

The cathodically active material layer 106 may be an intercalation-type chemistry active material, a conversion chemistry active material, or a combination thereof.

Exemplary conversion chemistry materials useful in the present disclosure include, but are not limited to, S (or Li₂S in the lithiated state), LiF, Fe, Cu, Ni, FeF₂, FeO_{d}F_{3.2d}, FeF₃, CoF₃, CoF₂, CuF₂, NiF₂, where 0≤d≤0.5, and the like.

Exemplary cathodically active material layers 106 also include any of a wide range of intercalation-type cathodically active materials. For example, for a lithium-ion battery, the cathodically active material may comprise a cathodically active material selected from transition metal oxides, transition metal sulfides, transition metal nitrides, lithium-transition metal oxides, lithium-transition metal sulfides, and lithium-transition metal nitrides may be selectively used. The transition metal elements of these transition metal oxides, transition metal sulfides, and transition metal nitrides can include metal elements having a d-shell or f-shell. Specific examples of such metal element are Sc, Y, lanthanoids, actinoids, Ti, Zr, Hf, V, Nb, Ta, Cr, Mo, W, Mn, Tc, Re, Fe, Ru, Os, Co, Rh, Ir, Ni, Pb, Pt, Cu, Ag, and Au. Additional cathodically active materials include LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co_{z})O₂, and combinations thereof.

In general, the cathodically active material layers 106 will have a thickness of at least about 20 μm. For example, in one embodiment, the cathodically active material layers 106 will have a thickness of at least about 40 μm. By way of further example, in one such embodiment, the cathodically active material layers 106 will have a thickness of at least about 60 μm. By way of further example, in one such embodiment, the cathodically active material layers 106 will have a thickness of at least about 100 μm. Typically, the cathodically active material layers 106 will have a thickness of less than about 90 μm or less than about 70 μm.

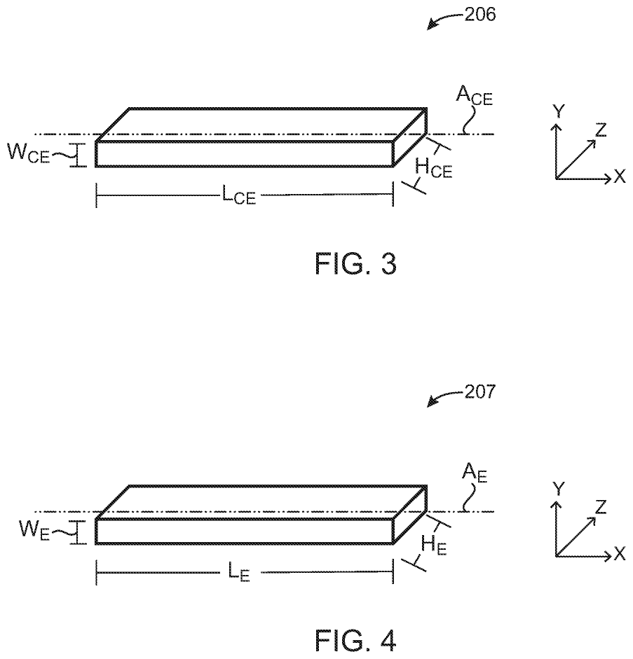

FIG. 3 depicts one of the cathode structures 206 of FIG. 2. Each cathode structure 206 has a length (L_{CE}) measured along the longitudinal axis (A_{CE}), a width (W_{CE}), and a height (H_{CE}) measured in a direction that is perpendicular to each of the directions of measurement of the length L_{CE} and the width W_{CE}.

The length L_{CE} of the cathode structures 206 will vary depending upon the secondary battery 100 and its intended use. In general, however, each cathode structure 206 will typically have a length L_{CE} in the range of about 5 millimeters (mm) to about 500 mm. For example, in one such embodiment, each cathode structure 206 has a length L_{CE} of about 10 mm to about 250 mm. By way of further example, in one such embodiment each cathode structure 206 has a length L_{CE} of about 25 mm to about 100 mm. According to one embodiment, the cathode structures 206 include one or more first electrode members having a first length, and one or more second electrode members having a second length that is different than the first length. In yet another embodiment, the different lengths for the one or more first electrode members and one or more second electrode members may be selected to accommodate a predetermined shape for an electrode assembly, such as an electrode assembly shape having a different lengths along one or more of the longitudinal and/or transverse axis, and/or to provide predetermined performance characteristics for the secondary battery 100.

The width W_{CE} of the cathode structures 206 will also vary depending upon the secondary battery 100 and its intended use. In general, however, the cathode structures 206 will typically have a width W_{CE} within the range of about 0.01 mm to 2.5 mm. For example, in one embodiment, the width W_{CE} of each cathode structure 206 will be in the range of about 0.025 mm to about 2 mm. By way of further example, in one embodiment, the width W_{CE} of each cathode structure 206 will be in the range of about 0.05 mm to about 1 mm. According to one embodiment, the cathode structures 206 include one or more first electrode members having a first width, and one or more second electrode members having a second width that is different than the first width. In yet another embodiment, the different widths for the one or more first electrode members and one or more second electrode members may be selected to accommodate a predetermined shape for the secondary battery 100, such as an assembly having a different widths along one or more of the longitudinal and/or transverse axis, and/or to provide predetermined performance characteristics for the secondary battery 100.

The height H_{CE} of the cathode structures 206 will also vary depending upon the secondary battery 100 and its intended use. In general, however, the cathode structures 206 will typically have a height H_{CE} within the range of about 0.05 mm to about 25 mm. For example, in one embodiment, the height H_{CE} of each cathode structure 206 will be in the range of about 0.05 mm to about 5 mm. By way of further example, in one embodiment, the height H_{CE} of each cathode structure 206 will be in the range of about 0.1 mm to about 1 mm. According to one embodiment, the cathode structures 206 include one or more first cathode members having a first height, and one or more second cathode members having a second height that is different than the first height. In yet another embodiment, the different heights for the one or more first cathode members and one or more second cathode members may be selected to accommodate a predetermined shape for the secondary battery 100, such as a shape having a different heights along one or more of the longitudinal and/or transverse axis, and/or to provide predetermined performance characteristics for the secondary battery 100.

In general, each cathode structure 206 has a length L_{CE} that is substantially greater than its width W_{CE} and substantially greater than its height H_{CE}. For example, in one embodiment, the ratio of L_{CE} to each of W_{CE} and H_{CE} is at least 5:1, respectively (that is, the ratio of L_{CE} to W_{CE} is at least 5:1, respectively and the ratio of L_{CE} to H_{CE} is at least 5:1, respectively), for each cathode structure 206. By way of further example, in one embodiment the ratio of L_{CE} to each of W_{CE} and H_{CE} is at least 10:1 for each cathode structure 206. By way of further example, in one embodiment, the ratio of L_{CE} to each of W_{CE} and H_{CE} is at least 15:1 for each cathode structure 206. By way of further example, in one embodiment, the ratio of L_{CE} to each of W_{CE} and H_{CE} is at least 20:1 for each cathode structure 206.

In one embodiment, the ratio of the height H_{CE} to the width W_{CE} of the cathode structures 206 is at least 0.4:1, respectively. For example, in one embodiment, the ratio of H_{CE} to W_{CE} will be at least 2:1, respectively, for each cathode structure 206. By way of further example, in one embodiment, the ratio of H_{CE} to W_{CE} will be at least 10:1, respectively, for each cathode structure 206. By way of further example, in one embodiment, the ratio of H_{CE} to W_{CE} will be at least 20:1, respectively, for each cathode structure 206. Typically, however, the ratio of H_{CE} to W_{CE} will generally be less than 1,000:1, respectively, for each cathode structure 206. For example, in one embodiment, the ratio of H_{CE} to W_{CE} will be less than 500:1, respectively, for each cathode structure 206. By way of further example, in one embodiment, the ratio of H_{CE} to W_{CE} will be less than 100:1, respectively. By way of further example, in one embodiment, the ratio of H_{CE} to W_{CE} will be less than 10:1, respectively. By way of further example, in one embodiment, the ratio of H_{CE} to W_{CE} will be in the range of about 2:1 to about 100:1, respectively, for each cathode structure 206.

### Anodic Type Structures and Materials

Referring again to FIG. 2, the anode current collector 202 in the unit cell 200 may comprise a conductive material such as copper, carbon, nickel, stainless-steel, cobalt, titanium, and tungsten, and alloys thereof, or any other material suitable as an anode current collector layer. In general, the anode current collector 202 will have an electrical conductivity of at least about 10³ Siemens/cm. For example, in one such embodiment, the anode current collector 202 will have a conductivity of at least about 10⁴ Siemens/cm. By way of further example, in one such embodiment, the anode current collector 202 will have a conductivity of at least about 10⁵ Siemens/cm.

In general, the anodically active material layers 104 in the unit cell 200 may be selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo2O4; (f) particles of graphite and carbon; (g) lithium metal; and (h) combinations thereof.

Exemplary anodically active material layers 104 include carbon materials such as graphite and soft or hard carbons, or graphene (e.g., single-walled or multi-walled carbon nanotubes), or any of a range of metals, semi-metals, alloys, oxides, nitrides and compounds capable of intercalating lithium or forming an alloy with lithium. Specific examples of the metals or semi-metals capable of constituting the anode material include graphite, tin, lead, magnesium, aluminum, boron, gallium, silicon, Si/C composites, Si/graphite blends, silicon oxide (SiOx), porous Si, intermetallic Si alloys, indium, zirconium, germanium, bismuth, cadmium, antimony, silver, zinc, arsenic, hafnium, yttrium, lithium, sodium, graphite, carbon, lithium titanate, palladium, and mixtures thereof. In one exemplary embodiment, the anodically active material comprises aluminum, tin, or silicon, or an oxide thereof, a nitride thereof, a fluoride thereof, or other alloy thereof. In another exemplary embodiment, the anodically active material layers 104 comprise silicon or an alloy or oxide thereof.

In one embodiment, the anodically active material layers 104 are microstructured to provide a significant void volume fraction to accommodate volume expansion and contraction as lithium ions (or other carrier ions) are incorporated into or leave the anodically active material layers 104 during charging and discharging processes for the secondary battery 100. In general, the void volume fraction of (each of) the anodically active material layer 104 is at least 0.1. Typically, however, the void volume fraction of (each of) the anodically active material layer 104 is not greater than 0.8. For example, in one embodiment, the void volume fraction of (each of) the anodically active material layer 104 is about 0.15 to about 0.75. By way of the further example, in one embodiment, the void volume fraction of (each of) the anodically active material layer 104 is about 0.2 to about 0.7. By way of the further example, in one embodiment, the void volume fraction of (each of) the anodically active material layer 104 is about 0.25 to about 0.6.

Depending upon the composition of the microstructured anodically active material layers 104 and the method of their formation, the microstructured anodically active material layers 104 may comprise macroporous, microporous, or mesoporous material layers or a combination thereof, such as a combination of microporous and mesoporous, or a combination of mesoporous and macroporous. Microporous material is typically characterized by a pore dimension of less than 10 nanometer (nm), a wall dimension of less than 10 nm, a pore depth of 1 μm to 50 μm, and a pore morphology that is generally characterized by a “spongy” and irregular appearance, walls that are not smooth, and branched pores. Mesoporous material is typically characterized by a pore dimension of 10 nm to 50 nm, a wall dimension of 10 nm to 50 nm, a pore depth of 1 μm to 100 μm, and a pore morphology that is generally characterized by branched pores that are somewhat well defined or dendritic pores. Macroporous material is typically characterized by a pore dimension of greater than 50 nm, a wall dimension of greater than 50 nm, a pore depth of 1 μm to 500 μm, and a pore morphology that may be varied, straight, branched, or dendritic, and smooth or rough-walled. Additionally, the void volume may comprise open or closed voids, or a combination thereof. In one embodiment, the void volume comprises open voids, that is, the anodically active material layers 104 contain voids having openings at the lateral surface of the anodically active material layers through which lithium ions (or other carrier ions) can enter or leave. For example, lithium ions may enter the anodically active material layers 104 through the void openings after leaving the cathodically active material layers 106. In another embodiment, the void volume comprises closed voids, that is, the anodically active material layers 104 contain voids that are enclosed. In general, open voids can provide greater interfacial surface area for the carrier ions whereas closed voids tend to be less susceptible to SEI formation, while each provides room for the expansion of anodically active material layers 104 upon the entry of carrier ions. In certain embodiments, therefore, it is preferred that the anodically active material layers 104 comprise a combination of open and closed voids.

In one embodiment, the anodically active material layers 104 comprise porous aluminum, tin or silicon or an alloy, an oxide, or a nitride thereof. Porous silicon layers may be formed, for example, by anodization, by etching (e.g., by depositing precious metals such as gold, platinum, silver or gold/palladium on the surface of single crystal silicon and etching the surface with a mixture of hydrofluoric acid and hydrogen peroxide), or by other methods known in the art such as patterned chemical etching. Additionally, the porous anodically active material layers 104 will generally have a porosity fraction of at least about 0.1, but less than 0.8 and have a thickness of about 1 μm to about 100 μm. For example, in one embodiment, the anodically active material layers 104 comprise porous silicon, have a thickness of about 5 μm to about 100 μm, and have a porosity fraction of about 0.15 to about 0.75. By way of further example, in one embodiment, the anodically active material layers 104 comprise porous silicon, have a thickness of about 10 μm to about 80 μm, and have a porosity fraction of about 0.15 to about 0.7. By way of further example, in one such embodiment, the anodically active material layers 104 comprise porous silicon, have a thickness of about 20 μm to about 50 μm, and have a porosity fraction of about 0.25 to about 0.6. By way of further example, in one embodiment, the anodically active material layers 104 comprise a porous silicon alloy (such as nickel silicide), have a thickness of about 5 μm to about 100 μm, and have a porosity fraction of about 0.15 to about 0.75.

In another embodiment, the anodically active material layers 104 comprise fibers of aluminum, tin, or silicon, or an alloy thereof. Individual fibers may have a diameter (thickness dimension) of about 5 nm to about 10,000 nm and a length generally corresponding to the thickness of the anodically active material layers 104. Fibers (nanowires) of silicon may be formed, for example, by chemical vapor deposition or other techniques known in the art such as vapor liquid solid (VLS) growth and solid liquid solid (SLS) growth. Additionally, the anodically active material layers 104 will generally have a porosity fraction of at least about 0.1, but less than 0.8 and have a thickness of about 1 μm to about 200 μm. For example, in one embodiment, the anodically active material layers 104 comprise silicon nanowires, have a thickness of about 5 μm to about 100 μm, and a porosity fraction of about 0.15 to about 0.75. By way of further example, in one embodiment, the anodically active material layers 104 comprise silicon nanowires, have a thickness of about 10 μm to about 80 μm, and a porosity fraction of about 0.15 to about 0.7. By way of further example, in one such embodiment, the anodically active material layers 104 comprise silicon nanowires, have a thickness of about 20 μm to about 50 μm, and a porosity fraction of about 0.25 to about 0.6. By way of further example, in one embodiment, the anodically active material layers 104 comprise nanowires of a silicon alloy (such as nickel silicide), have a thickness of about 5 μm to about 100 μm, and a porosity fraction of about 0.15 to about 0.75.

In yet other embodiments, the anodically active material layers 104 are coated with a particulate lithium material selected from the group consisting of stabilized lithium metal particles, e.g., lithium carbonate-stabilized lithium metal powder, lithium silicate stabilized lithium metal powder, or other source of stabilized lithium metal powder or ink. The particulate lithium material may be applied on the anodically active material layers 104 by spraying, loading, or otherwise disposing the lithium particulate material onto the anodically active material layers 104 at a loading amount of about 0.05 mg/cm² to 5 mg/cm², e.g., about 0.1 mg/cm² to 4 mg/cm², or even about 0.5 mg/cm² to 3 mg/cm². The average particle size (D₅₀) of the lithium particulate material may be 5 μm to 200 μm, e.g., about 10 μm to 100 μm, 20 μm to 80 μm, or even about 30 μm to 50 μm. The average particle size (D₅₀) may be defined as a particle size corresponding to 50% in a cumulative volume-based particle size distribution curve. The average particle size (D₅₀) may be measured, for example, using a laser diffraction method.

In one embodiment, the anode current collector 202, has an electrical conductance that is substantially greater than the electrical conductance of its associated anodically active material layers 104. For example, in one embodiment, the ratio of the electrical conductance of the anode current collector 202 to the electrical conductance of the anodically active material layers 104 is at least 100:1 when there is an applied current to store energy in the secondary battery 100 or an applied load to discharge the secondary battery 100. By way of further example, in some embodiments, the ratio of the electrical conductance of the anode current collector 202 to the electrical conductance of the anodically active material layers 104 is at least 500:1 when there is an applied current to store energy in the secondary battery 100 or an applied load to discharge the secondary battery 100. By way of further example, in some embodiments, the ratio of the electrical conductance of the anode current collector 202 to the electrical conductance of the anodically active material layers 104 is at least 1000:1 when there is an applied current to store energy in the secondary battery 100 or an applied load to discharge the secondary battery 100. By way of further example, in some embodiments, the ratio of the electrical conductance of the anode current collector 202 to the electrical conductance of the anodically active material layers 104 is at least 5000:1 when there is an applied current to store energy in the secondary battery 100 or an applied load to discharge the secondary battery 100. By way of further example, in some embodiments, the ratio of the electrical conductance of the anode current collector 202 to the electrical conductance of the anodically active material layers 104 is at least 10,000:1 when there is an applied current to store energy in the secondary battery 100 or an applied load to discharge the secondary battery 100.

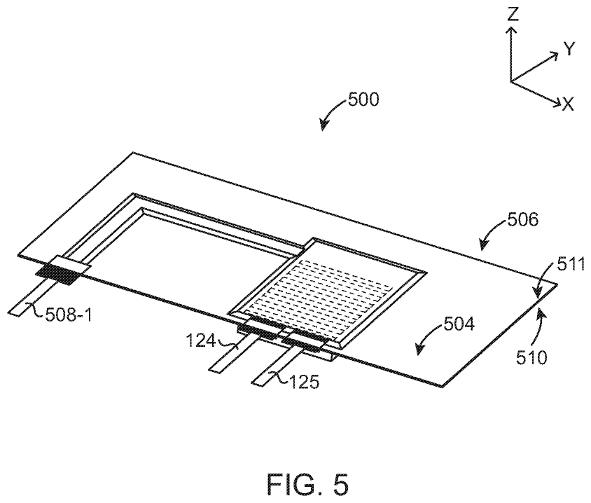

FIG. 4 depicts one of the anode structures 207 of FIG. 2 of an exemplary embodiment. Each anode structure 207 has a length (L_{E}) measured along a longitudinal axis (A_{E}) of the electrode, a width (W_{E}), and a height (H_{E}) measured in a direction that is orthogonal to each of the directions of measurement of the length L_{E} and the width W_{E}.

The length L_{E} of the anode structures 207 will vary depending upon the secondary battery 100 and its intended use. In general, however, the anode structures 207 will typically have a length L_{E} in the range of about 5 millimeter (mm) to about 500 mm. For example, in one such embodiment, the anode structures 207 have a length L_{E} of about 10 mm to about 250 mm. By way of further example, in one such embodiment, the anode structures 207 have a length L_{E} of about 25 mm to about 100 mm. According to one embodiment, the anode structure 207 include one or more first electrode members having a first length, and one or more second electrode members having a second length that is different than the first length. In yet another embodiment, the different lengths for the one or more first electrode members and the one or more second electrode members may be selected to accommodate a predetermined shape for the secondary battery 100, such as a shape having a different lengths along one or more of the longitudinal and/or transverse axis, and/or to provide predetermined performance characteristics for the secondary battery 100.

The width W_{E} of the anode structures 207 will also vary depending upon the secondary battery 100 and its intended use. In general, however, each anode structure 207 will typically have a width W_{E} within the range of about 0.01 mm to 2.5 mm. For example, in one embodiment, the width W_{E} of each anode structure 207 will be in the range of about 0.025 mm to about 2 mm. By way of further example, in one embodiment, the width W_{E} of each anode structure 207 will be in the range of about 0.05 mm to about 1 mm. According to one embodiment, the anode structures 207 include one or more first electrode members having a first width, and one or more second electrode members having a second width that is different than the first width. In yet another embodiment, the different widths for the one or more first electrode members and one or more second electrode members may be selected to accommodate a predetermined shape for the secondary battery 100, such as a shape having a different widths along one or more of the longitudinal and/or transverse axis, and/or to provide predetermined performance characteristics for the secondary battery 100.

The height H_{E} of the anode structures 207 will also vary depending upon the secondary battery 100 and its intended use. In general, however, the anode structures 207 will typically have a height H_{E} within the range of about 0.05 mm to about 25 mm. For example, in one embodiment, the height H_{E} of each anode structure 207 will be in the range of about 0.05 mm to about 5 mm. By way of further example, in one embodiment, the height H_{E} of each anode structure 207 will be in the range of about 0.1 mm to about 1 mm. According to one embodiment, the anode structures 207 include one or more first electrode members having a first height, and one or more second electrode members having a second height that is different than the first height. In yet another embodiment, the different heights for the one or more first electrode members and one or more second electrode members may be selected to accommodate a predetermined shape for the secondary battery 100, such as a shape having a different heights along one or more of the longitudinal and/or transverse axis, and/or to provide predetermined performance characteristics for the secondary battery 100.

In general, the anode structures 207 each have a length L_{E} that is substantially greater than each of its width W_{E} and its height H_{E}. For example, in one embodiment, the ratio of L_{E} to each of W_{E} and H_{E} is at least 5:1, respectively (that is, the ratio of L_{E} to W_{E} is at least 5:1, respectively and the ratio of L_{E} to H_{E} is at least 5:1, respectively), for each anode structure 207. By way of further example, in one embodiment, the ratio of L_{E} to each of W_{E} and H_{E} is at least 10:1. By way of further example, in one embodiment, the ratio of L_{E} to each of W_{E} and H_{E} is at least 15:1. By way of further example, in one embodiment, the ratio of L_{E} to each of W_{E} and H_{E} is at least 20:1, for each anode structure 207.

In one embodiment, the ratio of the height H_{E} to the width W_{E} of the anode structures 207 is at least 0.4:1, respectively. For example, in one embodiment, the ratio of H_{E} to W_{E} will be at least 2:1, respectively, for each anode structure 207. By way of further example, in one embodiment, the ratio of H_{E} to W_{E} will be at least 10:1, respectively. By way of further example, in one embodiment, the ratio of H_{E} to W_{E} will be at least 20:1, respectively. Typically, however, the ratio of H_{E} to W_{E} will generally be less than 1,000:1, respectively. For example, in one embodiment, the ratio of H_{E} to W_{E} will be less than 500:1, respectively. By way of further example, in one embodiment, the ratio of H_{E} to W_{E} will be less than 100:1, respectively. By way of further example, in one embodiment, the ratio of H_{E} to W_{E} will be less than 10:1, respectively. By way of further example, in one embodiment, the ratio of H_{E} to W_{E} will be in the range of about 2:1 to about 100:1, respectively, for each anode structure 207.

### Separator Structures, Separator Materials, and Electrolytes

Referring again to FIG. 2, the separator layer(s) 108 separate the cathode structures 206 from the anode structures 207. The separator layers 108 are made of electrically insulating but ionically permeable separator material. The separator layers 108 are adapted to electrically isolate each member of the plurality of the cathode structures 206 from each member of the plurality of the anode structures 207. Each separator layer 108 will typically include a microporous separator material that can be permeated with a non-aqueous electrolyte; for example, in one embodiment, the microporous separator material includes pores having a diameter of at least 50 Angstroms (Å), more typically in the range of about 2,500 Å, and a porosity in the range of about 25% to about 75%, more typically in the range of about 35% to 55%

In general, the separator layers 108 will each have a thickness of at least about 4 μm. For example, in one embodiment, the separator layers 108 will have a thickness of at least about 8 μm. By way of further example, in one such embodiment, the separator layers 108 will have a thickness of at least about 12 μm. By way of further example, in one such embodiment, the separator layers 108 will have a thickness of at least about 15 μm. In some embodiments, the separator layers 108 will have a thickness of up to 25 μm, up to 50 or any other suitable thickness. Typically, however, the separator layers 108 will have a thickness of less than about 12 μm or less than about 10 μm.

In general, the material of the separator layers 108 may be selected from a wide range of material having the capacity to conduct carrier ions between the anodically active material layers 104 and the cathodically active material layers 106 of the unit cell 200. For example, the separator layers 108 may comprise a microporous separator material that may be permeated with a liquid, non-aqueous electrolyte. Alternatively, the separator layers 108 may comprise a gel or solid electrolyte capable of conducting carrier ions between the anodically active material layers 104 and the cathodically active material layers 106 of the unit cell 200.

In one embodiment, the separator layers 108 may comprise a polymer-based electrolyte. Exemplary polymer electrolytes include PEO-based polymer electrolytes and polymer-ceramic composite electrolytes.

In another embodiment, the separator layers 108 may comprise an oxide-based electrolyte. Exemplary oxide-based electrolytes include lithium lanthanum titanate (Li_{0.34}La_{0.56}TiO₃), Al-doped lithium lanthanum zirconate (Li_{6.24}La₃Zr₂Al_{0.24}O_{11.98}), Ta-doped lithium lanthanum zirconate (Li_{6.4}La₃Zr_{1.4}Ta_{0.6}O₁₂), and lithium aluminum titanium phosphate (Li_{1.4}Al_{0.4}Ti_{1.6}(PO₄)₃).

In another embodiment, the separator layers 108 may comprise a solid electrolyte. Exemplary solid electrolytes include sulfide-based electrolytes such as lithium tin phosphorus sulfide (Li₁SnP₂Si₂), lithium phosphorus sulfide (β-Li₃PS₄), and lithium phosphorus sulfur chloride iodide (Li₆PS₅Cl_{0.9}I_{0.1}).

In some embodiments, the separator layers 108 may comprise a solid-state lithium ion conducting ceramic, such as a lithium-stuffed garnet.

In one embodiment, the separator layers 108 comprise a microporous separator material comprising a particulate material and a binder, with the microporous separator material having a porosity (void fraction) of at least about 20 vol. %. The pores of the microporous separator material will have a diameter of at least 50 Å and will typically fall within the range of about 250 Å to about 2,500 Å. The microporous separator material will typically have a porosity of less than about 75%. In one embodiment, the microporous separator material has a porosity (void fraction) of at least about 25 vol %. In one embodiment, the microporous separator material will have a porosity of about 35-55%.

The binder for the microporous separator material may be selected from a wide range of inorganic or polymeric materials. For example, in one embodiment, the binder is an organic material selected from the group consisting of silicates, phosphates, aluminates, aluminosilicates, and hydroxides such as magnesium hydroxide, calcium hydroxide, etc. For example, in one embodiment, the binder is a fluoropolymer derived from monomers containing vinylidene fluoride, hexafluoropropylene, tetrafluoropropene, and the like. In another embodiment, the binder is a polyolefin such as polyethylene, polypropylene, or polybutene, having any of a range of varying molecular weights and densities. In another embodiment, the binder is selected from the group consisting of ethylene-diene-propene terpolymer, polystyrene, polymethyl methacrylate, polyethylene glycol, polyvinyl acetate, polyvinyl butyral, polyacetal, and polyethyleneglycol diacrylate. In another embodiment, the binder is selected from the group consisting of methyl cellulose, carboxymethyl cellulose, styrene rubber, butadiene rubber, styrene-butadiene rubber, isoprene rubber, polyacrylamide, polyvinyl ether, polyacrylic acid, polymethacrylic acid, and polyethylene oxide. In another embodiment, the binder is selected from the group consisting of acrylates, styrenes, epoxies, and silicones. In another embodiment, the binder is a copolymer or blend of two or more of the aforementioned polymers.

The particulate material comprised by the microporous separator material may also be selected from a wide range of materials. In general, such materials have a relatively low electronic and ionic conductivity at operating temperatures and do not corrode under the operating voltages of the battery electrode or current collector contacting the microporous separator material. For example, in one embodiment, the particulate material has a conductivity for carrier ions (e.g., lithium) of less than 1×10⁻⁴ Siemens/cm (S/cm). By way of further example, in one embodiment, the particulate material has a conductivity for carrier ions of less than 1×10⁻⁵ S/cm. By way of further example, in one embodiment, the particulate material has a conductivity for carrier ions of less than 1×10⁻⁶ S/cm. Exemplary particulate materials include particulate polyethylene, polypropylene, a TiO₂-polymer composite, silica aerogel, fumed silica, silica gel, silica hydrogel, silica xerogel, silica sol, colloidal silica, alumina, titania, magnesia, kaolin, talc, diatomaceous earth, calcium silicate, aluminum silicate, calcium carbonate, magnesium carbonate, or a combination thereof. For example, in one embodiment, the particulate material comprises a particulate oxide or nitride such as TiO₂, SiO₂, Al₂O₃, GeO₂, B₂O₃, Bi₂O₃, BaO, ZnO, ZrO₂, BN, Si₃N₄, and Ge₃N₄. See, for example, P. Arora and J. Zhang, “Battery Separators” Chemical Reviews 2004, 104, 4419-4462). In one embodiment, the particulate material will have an average particle size of about 20 nm to 2 μm, more typically 200 nm to 1.5 μm. In one embodiment, the particulate material will have an average particle size of about 500 nm to 1 μm.

In an alternative embodiment, the particulate material comprised by the microporous separator material may be bound by techniques such as sintering, binding, curing, etc. while maintaining the void fraction desired for electrolyte ingress to provide the ionic conductivity for the functioning of the battery.

In the secondary battery 100 (see FIG. 1), the microporous separator material of the separator layers 108 are permeated with a non-aqueous electrolyte suitable for use as a secondary battery electrolyte. Typically, the non-aqueous electrolyte comprises a lithium salt and/or mixture of salts dissolved in an organic solvent and/or solvent mixture. Exemplary lithium salts include inorganic lithium salts such as LiClO₄, LiBF₄, LiPF₆, LiAsF₆, LiCl, and LiBr; and organic lithium salts such as LiB(C₆H₅)₄, LiN(SO₂CF₃)₂, LiN(SO₂CF₃)₃, LiNSO₂CF₃, LiNSO₂CF₅, LiNSO₂C₄F₉, LiNSO₂C₅F₁₁, LiNSO₂C₆Fi₃, and LiNSO₂C₇Fi₅. Exemplary organic solvents to dissolve the lithium salt include cyclic esters, chain esters, cyclic ethers, and chain ethers. Specific examples of the cyclic esters include propylene carbonate, butylene carbonate, γ-butyrolactone, vinylene carbonate, 2-methyl-γ-butyrolactone, acetyl-γ-butyrolactone, and γ-valerolactone. Specific examples of the chain esters include dimethyl carbonate, diethyl carbonate, dibutyl carbonate, dipropyl carbonate, methyl ethyl carbonate, methyl butyl carbonate, methyl propyl carbonate, ethyl butyl carbonate, ethyl propyl carbonate, butyl propyl carbonate, alkyl propionates, dialkyl malonates, and alkyl acetates. Specific examples of the cyclic ethers include tetrahydrofuran, alkyltetrahydrofurans, dialkyltetrahydrofurans, alkoxytetrahydrofurans, dialkoxytetrahydrofurans, 1,3-dioxolane, alkyl-1,3-dioxolanes, and 1,4-dioxolane. Specific examples of the chain ethers include 1,2-dimethoxyethane, 1,2-diethoxythane, diethyl ether, ethylene glycol dialkyl ethers, diethylene glycol dialkyl ethers, triethylene glycol dialkyl ethers, and tetraethylene glycol dialkyl ethers.

### ADDITIONAL EMBODIMENTS OF THE PRESENT DISCLOSURE

When a secondary battery is assembled, the amount of carrier ions available for cycling between the anode and the cathode is often initially provided in the cathode, because cathodically active materials, such as lithium cobalt oxide, are relatively stable in ambient air (e.g., they resist oxidation) compared to lithiated anode materials, such as lithiated graphite. When a secondary battery is charged for the first time, the carrier ions are extracted from the cathode and introduced into the anode. As a result, the anode potential is lowered significantly (toward the potential of the carrier ions), and the cathode potential is increased (to become even more positive). These changes in potential may give rise to parasitic reactions on both the cathode and the anode, but sometimes more severely on the anode. For example, a decomposition product comprising lithium (or other carrier ions) and electrolyte components, known as solid electrolyte interphase (SEI), may readily form on the surfaces of carbon anodes. These surfaces or covering layers are carrier ion conductors, which establish an ionic connection between the anode and the electrolyte and prevent the reactions from proceeding any further.

Although formation of the SEI layer is desired for the stability of a half-cell system comprising the anode and the electrolyte, a portion of the carrier ions introduced into the cells via the cathode is irreversibly bound and thus removed from cyclic operation, i.e., from the capacity available to the user. As a result, during the initial discharge, fewer carrier ions are returned to the cathode from the anode than was initially provided by the cathode during the initial charging operation, leading to irreversible capacity loss. During each subsequent charge and discharge cycle, the capacity losses resulting from mechanical and/or electrical degradation to the anode and/or the cathode tend to be much less per cycle, but even the relatively small carrier ion losses per cycle contribute significantly to reductions in energy density and cycle life as the battery ages. In addition, chemical and electrochemical degradation may also occur on the electrodes and cause capacity losses. To compensate for the formation of SEI (or another carrier ion-consuming mechanism such as mechanical and/or electrical degradation of the negative electrode), additional or supplementary carrier ions may be provided from an auxiliary electrode after formation of the battery.

In general, the positive electrode 208 of the secondary battery 100 (e.g., the collective population of the cathode structures 206 in the secondary battery 100) preferably has a reversible coulombic capacity that is matched to the discharge capacity of the negative electrode 209 (e.g., the collective population of the anode structures 207 in the secondary battery 100). Stated differently, the positive electrode 208 of the secondary battery 100 is sized to have a reversible coulombic capacity that corresponds to the discharge capacity of the negative electrode 209 which, in turn, is a function of the negative electrode 209 end of discharge voltage.

In some embodiments, the negative electrode 209 of the secondary battery 100 (e.g., the collective population of the anode structures 207 in the secondary battery 100) is designed to have a reversible coulombic capacity that exceeds the reversible coulombic capacity of the positive electrode 208. For example, in one embodiment, a ratio of the reversible coulombic capacity of the negative electrode 209 to the reversible coulombic capacity of the positive electrode 208 is at least 1.2:1, respectively. By way of further example, in one embodiment, a ratio of the reversible coulombic capacity of the negative electrode 209 to the reversible coulombic capacity of the positive electrode 208 is at least 1.3:1, respectively. By way of further example, in one embodiment, a ratio of the reversible coulombic capacity of the negative electrode 209 to the reversible coulombic capacity of the positive electrode 208 is at least 2:1, respectively. By way of further example, in one embodiment, a ratio of the reversible coulombic capacity of the negative electrode 209 to the reversible coulombic capacity of the positive electrode 208 is at least 3:1, respectively. By way of further example, a ratio of the reversible coulombic capacity of the negative electrode 209 to the reversible coulombic capacity of the positive electrode 208 is at least 4:1, respectively. By way of further example, a ratio of the reversible coulombic capacity of the negative electrode 209 to the reversible coulombic capacity of the positive electrode 208 is at least 5:1, respectively. Advantageously, the excess coulombic capacity of the negative electrode 209 provides a source of anodically active material to allow the secondary battery 100 to reversibly operate within a specified voltage that inhibits formation of crystalline phases (incorporating carrier ions) on the negative electrode 209 that reduce cycle-life of the negative electrode 209 as result of cycling.

As previously noted, the formation of SEI during the initial charge/discharge cycle reduces the amount of carrier ions available for reversible cycling. Mechanical and/or electrical degradation of the negative electrode 209 during cycling of the secondary battery 100 may further reduce the amount of carrier ions available for reversible cycling. To compensate for the formation of SEI (or another carrier ion-consuming mechanism such as mechanical and/or electrical degradation of the negative electrode), therefore, additional or supplementary carrier ions may be provided from an auxiliary electrode after formation of the secondary battery 100. In the embodiments of the present disclosure, the auxiliary electrode is used to electrochemically transfer additional carrier ions to the positive electrode 208 and/or the negative electrode 209 of the secondary battery 100 during and/or after formation. In one embodiment, the auxiliary electrode is removed after transferring the additional carrier ions to the secondary battery 100 in order to improve the energy density of the secondary battery in its final form.

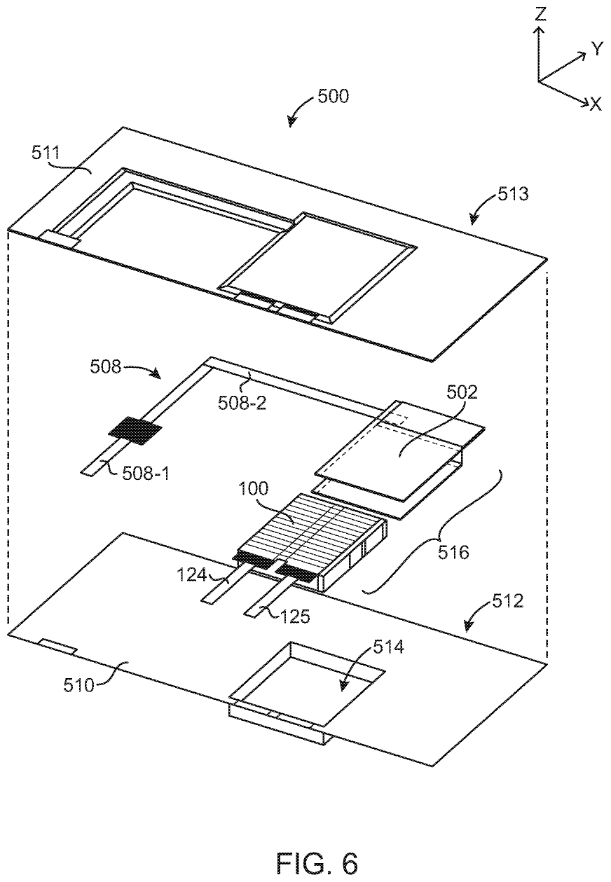

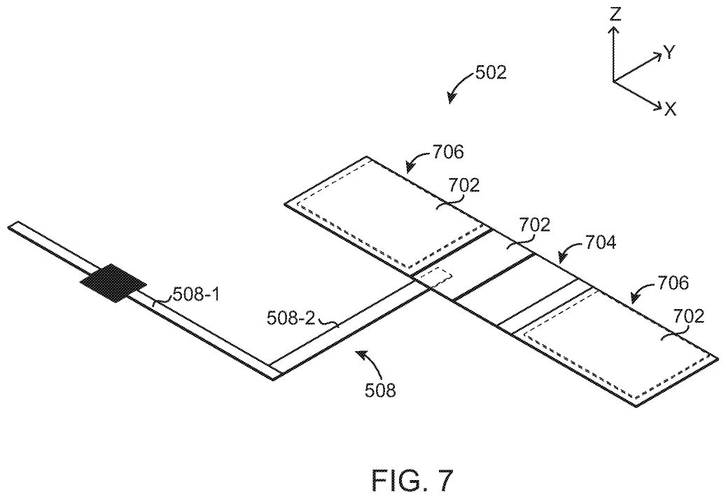

FIG. 5 is a perspective view of a buffer system 500 of an exemplary embodiment, and FIG. 6 is an exploded view of the buffer system 500. Generally, the buffer system 500 may be temporarily assembled during or after initial formation of the secondary battery 100 and the buffer system 500 is used to introduce additional carrier ions into the positive electrode 208 and/or the negative electrode 209 of the secondary battery 100 using an auxiliary electrode 502 (see FIG. 6). In this embodiment, the buffer system 500 includes an enclosure 504 that encapsulates the auxiliary electrode 502 (see FIG. 6) and the secondary battery 100 within a perimeter 506 of the enclosure 504. In FIG. 5, the electrical terminals 124, 125 of the secondary battery 100 and a segment of a conductive tab 508-1 extend from the perimeter 506 of the enclosure 504, providing electrical connections to the auxiliary electrode 502 and the secondary battery 100. In this embodiment, the enclosure 504 comprises a first enclosure layer 510 and a second enclosure layer 511 that are joined together to form the enclosure 504.

Referring to FIG. 6, the first enclosure layer 510 has a perimeter 512 and the second enclosure layer 511 has a perimeter 513. Each of the enclosure layers 510, 511 may comprise a flexible or semi-flexible material, such as aluminum, polymer, a thin film flexible metal, or the like. In one embodiment, one or more of the enclosure layers 510, 511 comprises a multi-layer aluminum polymer material, plastic, or the like. In another embodiment, one or more of the enclosure layers 510, 511 comprises a polymer material laminated on a metal substrate, such as aluminum. In one embodiment, the first enclosure layer 510 includes a pouch 514 (e.g., an indentation) that is sized and shaped to match the outer surface size and shape of the secondary battery 100.

The auxiliary electrode 502 partially surrounds the secondary battery 100 in the buffer system 500, and contains a source of carrier ions to replenish the lost energy capacity of the secondary battery 100 after formation (i.e., to compensate for the loss of carrier ions upon the formation of SEI and other carrier ion losses in the first charge and/or discharge cycle of the secondary battery 100). In embodiments, the auxiliary electrode 502 may comprise a foil of the carrier ions in metallic form (e.g., a foil of lithium, magnesium, or aluminum), or any of the previously mentioned materials used for the cathodically active material layers 106 and/or the anodically active material layers 104 (see FIG. 2) in their carrier ion-containing form. For example, the auxiliary electrode 502 may comprise lithiated silicon or a lithiated silicon alloy. When the buffer system 500 is assembled, the combination of the auxiliary electrode 502 and the secondary battery 100, which may be referred to as an auxiliary subassembly 516 (see FIG. 6), are inserted into the pouch 514, and the enclosure layers 510, 511 are sealed together to form the buffer system 500 as depicted in FIG. 5. The specific details of the assembly process for the buffer system 500 and how the buffer system 500 is used during a carrier ion transfer process to the secondary battery 100 will be discussed in more detail below. The auxiliary electrode 502 in this embodiment includes an electrically conductive tab 508, which may be segmented into a conductive tab 508-2 that is covered by the enclosure 504 and a conductive tab 508-1 that is partially exposed by the enclosure as depicted in FIG. 5, for example, for ease of manufacturing.

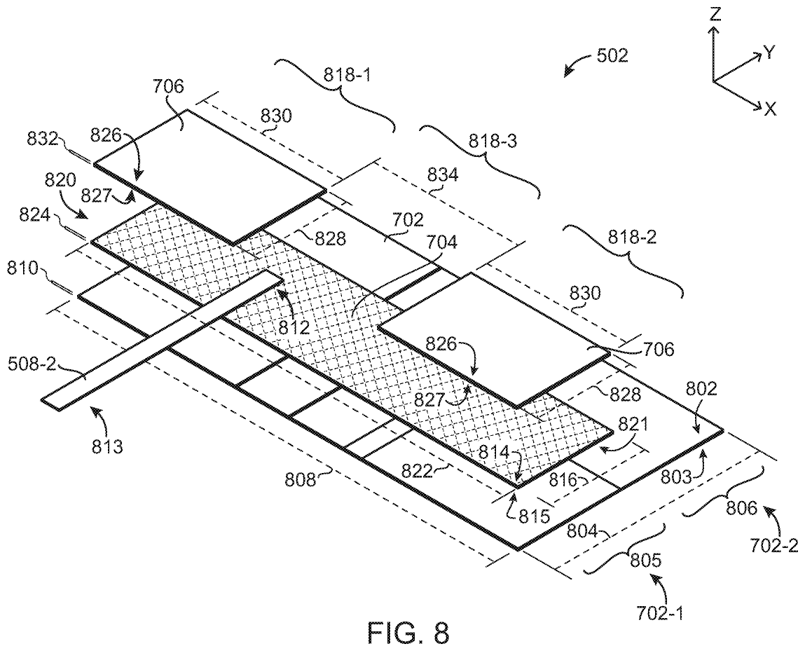

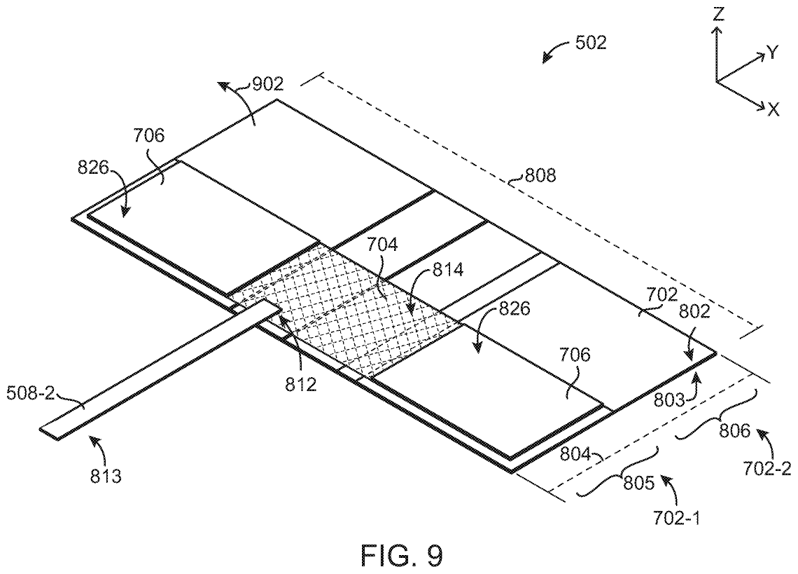

FIG. 7 is a perspective view of the auxiliary electrode 502 of an exemplary embodiment, and FIG. 8 is an exploded view of the auxiliary electrode. Referring to FIG. 7, the auxiliary electrode 502 generally includes a separator 702, which covers a conductive layer 704 and carrier ion supply layers 706. When the auxiliary electrode 502 is formed into the shape depicted in FIG. 6, the carrier ion supply layers 706 are located proximate to major surfaces 126, 127 of the secondary battery 100 (see FIG. 1), with the separator 702 insulating the casing 116 of the secondary battery 100 from the conductive layer 704 and the carrier ion supply layers 706. The separator 702 includes an electrolyte, which facilitates the transfer of carrier ions from the carrier ion supply layers 706 to the secondary battery 100 during a buffer process.

Referring to FIG. 8, the auxiliary electrode 502 includes, from bottom to top in FIG. 8, the separator 702, the conductive layer 704, and the population of carrier ion supply layers 706. The auxiliary electrode 502 in this embodiment further includes the conductive tab 508-2, which is electrically conductive and electrically coupled with the conductive layer 704. The conductive tab 508-2 provides an electrical connection with the auxiliary electrode 502. Generally, the auxiliary electrode 502 is used during the buffer process to transfer carrier ions from the carrier ion supply layers 706 to the positive electrode 208 and/or the negative electrode 209 of the secondary battery 100 during or after formation of the secondary battery 100.

The separator 702 may comprise any of the materials previously described with respect to the separator layer 108 of the secondary battery 100. The separator 702 may be permeated with an electrolyte that serves as a medium to conduct carrier ions from the carrier ion supply layers 706 to the positive electrode 208 of the secondary battery 100 and/or the negative electrode 209 of the secondary battery. The electrolyte may comprise any of the materials previously described with respect to the secondary battery 100.

The separator 702 in this embodiment includes a first surface 802 and a second surface 803 that opposes the first surface 802. The surfaces 802, 803 of the separator 702 form major surfaces for the separator 702 and are disposed in the X-Y plane in FIG. 8. The separator 702 in this embodiment has a width 804 that extends in a direction of the Y-axis. The separator 702 in this embodiment is segmented in the width 804 into a first portion 805 and a second portion 806. In some embodiments, the separator 702 may comprise a first separator layer 702-1 corresponding to the first portion 805 and a second separator layer 702-2 corresponding to the second portion 806.

In one embodiment, the width 804 of the separator 702 is about 34 mm. In other embodiments, the width 804 of the separator is about 30 mm, about 35 mm, or another suitable value. In some embodiments, the width 804 of the separator 702 lies in a range of values of about 10 mm to about 200 mm, or some other suitable range that allows the separator 702 to function as described herein.

The separator 702, in one embodiment, has a length 808 that extends in a direction of the X-axis. In an embodiment, the length 808 of the separator 702 is about 72 mm. In other embodiments, the length 808 of the separator 702 is about 65 mm, about 70 mm, about 75 mm, or some other suitable value that allows the separator 702 to function as described herein. In some embodiments, the length 808 of the separator 702 lies in a range of values of about 30 mm to about 200 mm, or some other suitable range of values that allows the separator 702 to function as described herein.

In one embodiment, the separator 702 has a thickness 810 that extends in the direction of the Z-axis. Generally, the thickness 810 is a distance from the first surface 802 of the separator 702 to (and including) the second surface 803 of the separator. In one embodiment, the thickness 810 of the separator 702 is about 0.025 mm. In other embodiments, the thickness 810 of the separator 702 is about 0.015 mm, about 0.02 mm, about 0.03 mm, about 0.035 mm, or some other suitable value. In some embodiments, the thickness 810 of the separator 702 lies in a range of values of about 0.01 mm to about 1.0 mm, or some other suitable range of values that allows the separator 702 to function as described herein.

The conductive layer 704 is electrically conductive, and may comprise a metal, a metalized film, an insulating base material with a conductive material applied thereto, or some other type of electrically conductive material. In some embodiments, the conductive layer 704 comprises copper. In other embodiments, the conductive layer 704 comprises aluminum or another metal. In this embodiment, the conductive layer 704 is electrically coupled with the conductive tab 508-2, which is also electrically conductive. The conductive tab 508-2 has a first end 812 disposed proximate to the conductive layer 704 and a second end 813 disposed distal to the conductive layer 704 that opposes the first end 812. The first end 812 of the conductive tab 508-2 is electrically coupled to the conductive layer 704. In some embodiments, the first end 812 of the conductive tab 508-2 is spot-welded to the conductive layer 704. In other embodiments, the first end 812 of the conductive tab 508-2 is soldered to the conductive layer 704. Generally, the conductive tab 508-2 may be affixed at the first end 812 to the conductive layer 704 using any suitable means that ensure a mechanical connection and an electrical connection to the conductive layer. The conductive tab 508-2 may comprise any type of electrically conductive material as desired. In one embodiment, the conductive tab 508-2 comprises a metal. In these embodiments, the conductive tab 508-2 may comprise nickel, copper, aluminum, or other suitable metals or metal alloys that allows the conductive tab 508-2 to function as described herein.

The conductive layer 704 in this embodiment includes a first surface 814 and a second surface 815 that opposes the first surface 814. The surfaces 814, 815 of the conductive layer 704 form major surfaces for the conductive layer 704 and are disposed in the X-Y plane in FIG. 8. The conductive layer 704 in this embodiment has a width 816 that extends in a direction of the Y-axis. In an embodiment, the width 816 of the conductive layer 704 is about 15 mm. In other embodiments, the width 816 of the conductive layer 704 is about 10 mm, about 20 mm, or some other suitable value that allows the conductive layer 704 to function as described herein.

In some embodiments, the width 816 of the conductive layer 704 lies in a range of values of about 5 mm to about 100 mm, or some other suitable range of values that allows the conductive layer 704 to function as described herein. The first surface 814 of the conductive layer 704 in this embodiment is segmented into a first region 818-1, disposed proximate to a first end 820 of the conductive layer 704, a second region 818-2, disposed proximate to a second end 821 of the conductive layer 704, and a third region 818-3 disposed between the first region 818-1 and the second region 818-2.

The conductive layer 704 has a length 822 that extends in a direction of the X-axis. In one embodiment, the length 822 of the conductive layer 704 is about 70 mm. In other embodiments, the length 822 of the conductive layer 704 is about 60 mm, about 65 mm, about 75 mm, or some other suitable value that allows the conductive layer 704 to function as described herein. In some embodiments, the length 822 of the conductive layer 704 lies in a range of values of about 30 mm to about 200 mm, or some other suitable range of values that allows the conductive layer 704 to function as described herein.

The conductive layer 704 has a thickness 824 that extends in a direction of the Z-axis. Generally, the thickness 824 is a distance from the first surface 814 of the conductive layer 704 to (and including) the second surface 815 of the conductive layer 704. In one embodiment, the thickness 824 of the conductive layer 704 is about 0.1 mm. In other embodiments, the thickness 824 of the conductive layer 704 is about 0.005 mm, about 0.15 mm, or about 0.2 mm. In some embodiments, the thickness 824 of the conductive layer 704 lies in a range of values of about 0.01 mm to about 1.0 mm, or any other suitable range for the thickness that allows the conductive layer 704 to function as described herein.

The carrier ion supply layers 706, which comprise a population of carrier ion supply layers 706 in an embodiment, comprise any carrier ion containing material previously described that may be utilized to supply carrier ions to the positive electrode 208 and/or the negative electrode 209 of the secondary battery 100. The carrier ion supply layers 706 may comprise one or more sources of lithium ions, sodium ions, potassium ions, calcium ions, magnesium ions, and aluminum ions. In this embodiment, the carrier ion supply layers 706 are disposed within the first region 818-1 and the second region 818-2 of the conductive layer 704. In some embodiments, the carrier ion supply layers 706 are also disposed in the third region 818-3 of the conductive layer 704.

The carrier ion supply layers 706 in this embodiment include a first surface 826 and a second surface 827 that opposes the first surface 826. The surfaces 826, 827 of the carrier ion supply layers 706 form major surfaces for the carrier ion supply layers 706 and are disposed in the X-Y plane in FIG. 8. The carrier ion supply layers 706 in this embodiment have a width 828 that extends in a direction of the Y-axis. In an embodiment, the width 828 of the carrier ion supply layers 706 are about 15 mm. In other embodiments, the width 828 of the carrier ion supply layers 706 are about 10 mm, about 20 mm, or some other suitable value that allow the carrier ion supply layers 706 to function as described herein. In some embodiments, the width 828 of the carrier ion supply layers 706 lies in a range of values of about 5 mm to about 100 mm, or some other suitable range of values that allows the carrier ion supply layers 706 to function as described herein.

The carrier ion supply layers 706, in one embodiment, have a length 830 that extends in a direction of the X-axis. In an embodiment, the length 830 of the carrier ion supply layers 706 are about 23 mm. In other embodiments, the length 830 of the carrier ion supply layers 706 are about 15 mm, about 20 mm, about 25 mm, or some other suitable length that allows the carrier ion supply layers 706 to function as described herein. In some embodiments, the length 830 of the carrier ion supply layers 706 lie in a range of values of about 10 mm to about 100 mm, or some other suitable range of values that allow the carrier ion supply layers 706 to function as described herein.

The carrier ion supply layers 706 each have a thickness 832 that extends in a direction of the Z-axis. Generally, the thickness 832 is a distance between the first surface 826 of the carrier ion supply layers 706 and the second surface 827 of the carrier ion supply layers 706. In one embodiment, the thickness 832 of the carrier ion supply layers 706 are about 0.13 mm. In other embodiments, the thickness 832 of the carrier ion supply layers 706 are about 0.005 mm, about 0.15 mm, or about 0.2 mm. In some embodiments, the thickness 832 of the carrier ion supply layers 706 lie in a range of values of about 0.01 mm to about 1.0 mm, or any other suitable range of values for the thickness 832 that allows the carrier ion supply layers 706 to function as described herein.

In this embodiment, the carrier ion supply layers 706 are separated from each other by a distance 834, corresponding to the third region 818-3. In one embodiment, the distance 834 is about 23 mm. In other embodiments, the distance 834 is about 15 mm, about 20 mm, about 25 mm, or about 30 mm. In some embodiments, the distance 834 lies in a range of values of about 10 mm to about 50 mm, or any other suitable range of values that allows the carrier ion supply layers 706 to function as described herein.

In one embodiment, the carrier ion supply layers 706 are sized to be capable of providing at least 15% of the reversible coulombic capacity of the positive electrode 208 of the secondary battery 100. For example, in one such embodiment, the carrier ion supply layers 706 are sized such that they contain sufficient carrier ions (e.g., lithium, magnesium, or aluminum ions) to provide at least 30% of the reversible coulombic capacity of the positive electrode 208 of the secondary battery 100. By way of further example, in one such embodiment, the carrier ion supply layers 706 are sized such that they contain sufficient carrier ions to provide at least 100% of the reversible coulombic capacity of the positive electrode 208 of the secondary battery 100. By way of further example, in one such embodiment, the carrier ion supply layers 706 are sized such that they contain sufficient carrier ions to provide at least 200% of the reversible coulombic capacity of the positive electrode 208 of the secondary battery 100. By way of further example, in one such embodiment, the carrier ion supply layers 706 are sized such that they contain sufficient carrier ions to provide at least 300% of the reversible coulombic capacity of the positive electrode 208 of the secondary battery 100. By way of further example, in one such embodiment, the carrier ion supply layers 706 are sized such that they contain sufficient carrier ions to provide about 100% to about 200% of the reversible coulombic capacity of the positive electrode 208 of the secondary battery 100.

During an assembly process for the auxiliary electrode 502, the separator 702 may be cut from stock material or prefabricated to achieve the width 804 and the length 808 as shown in FIG. 8. The conductive layer 704 may be cut from stock material or prefabricated to achieve the width 816 and the length 822 shown in FIG. 8. In some embodiments, the conductive layer 704 is prefabricated to include the conductive tab 508-2 with the first end 812 mechanically and electrically affixed to the conductive layer 704 as depicted in FIG. 8. In other embodiments, the conductive tab 508-2 is cut from a stock material and mechanically and electrically coupled with the conductive layer 704 (e.g., by spot welding or soldering first end 812 to the conductive layer 704). In some embodiments, the carrier ion supply layers 706 are cut to size from stock materials, and bonded or otherwise laminated to the conductive layer 704 (e.g., by cold welding the carrier ion supply layers 706 onto the conductive layer 704) to achieve the orientation depicted in FIG. 8, with the second surface 827 of the carrier ion supply layers 706 in contact with the first surface 814 of the conductive layer 704. For example, the material used to form the carrier ion supply layers 706 (e.g., lithium) may exist in stock form as rolls of lithium sheets that are cut to size.

In other embodiments, the conductive layer 704 is prefabricated to include the carrier ion supply layers 706 arranged in the orientation depicted in FIG. 8. In this embodiment, the conductive layer 704 is disposed within the first portion 805 of the separator 702 in a direction of the X-axis, with the second surface 815 of the conductive layer 704 contacting the first surface 802 of the separator 702.

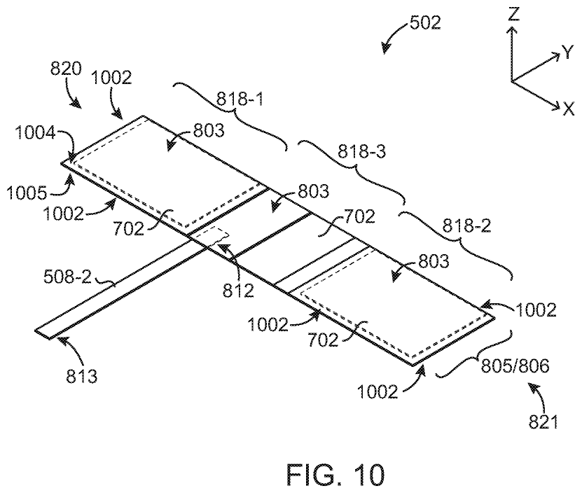

FIG. 9 is a perspective view of the auxiliary electrode 502 at an intermediate stage of the fabrication process for the auxiliary electrode. At this stage, the conductive layer 704 is disposed on the first portion 805 of the separator 702, and the conductive tab 508-2 extends to the left (in the Y-axis direction) in FIG. 9 from the first end 812, which is affixed to the conductive layer 704, away from the separator 702 and the conductive layer 704 towards the second end 813. The first surface 802 of the separator 702 is covered by the conductive layer 704 within the first portion 805 of the separator 702, while the first surface 802 of separator remains uncovered within the second portion 806 of the separator 702.

To continue the fabrication process of the auxiliary electrode 502, in one embodiment, the second portion 806 of the separator 702 is folded in the direction of an arrow 902 towards the left (about an axis parallel to the X-axis) in FIG. 9, such that the first surface 802 within the second portion 806 of the separator 702 contacts the first surfaces 826 of the carrier ion supply layers 706 and the first surface 814 of the conductive layer 704 that is exposed between the carrier ion supply layers 706. When the separator 702 comprises the first separator layer 702-1 and the second separator layer 702-2, the second separator layer may be placed such that the first surface 802 of the second separator layer contacts the first surfaces 826 of the carrier ion supply layers 706 and the first surface 814 of the conductive layer 704 that is exposed between the carrier ion supply layers 706.

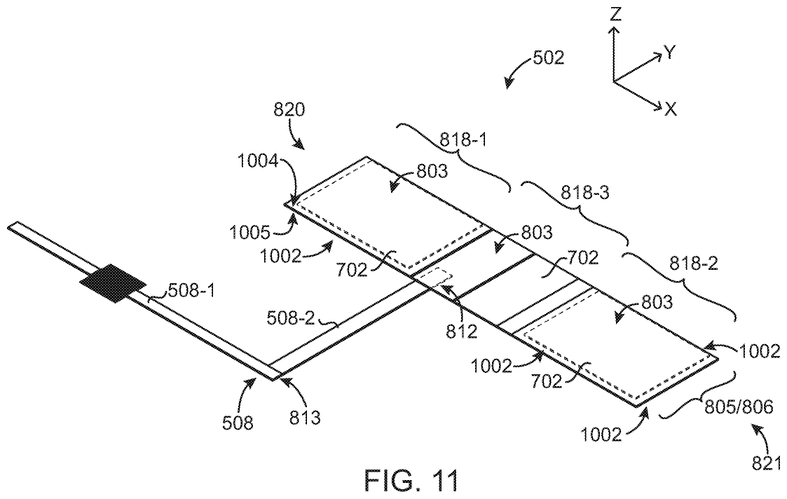

FIG. 10 is a perspective view of the auxiliary electrode 502 at another intermediate stage in the fabrication process, after folding the second portion 806 of the separator 702 as described above. At this stage, the separator 702 encapsulates the conductive layer 704 and the carrier ion supply layers 706, leaving a portion between the first end 812 of the conductive tab 508-2 and the second end 813 of the conductive tab 508-2 uncovered by the separator 702. The separator 702 may then be bonded to itself along at least a portion of an outer perimeter 1002 of the separator to encapsulate the conductive layer 704 within the first portion 805 of the separator and the second portion 806 of the separator along the first surface 802 of the separator (not visible in FIG. 10).

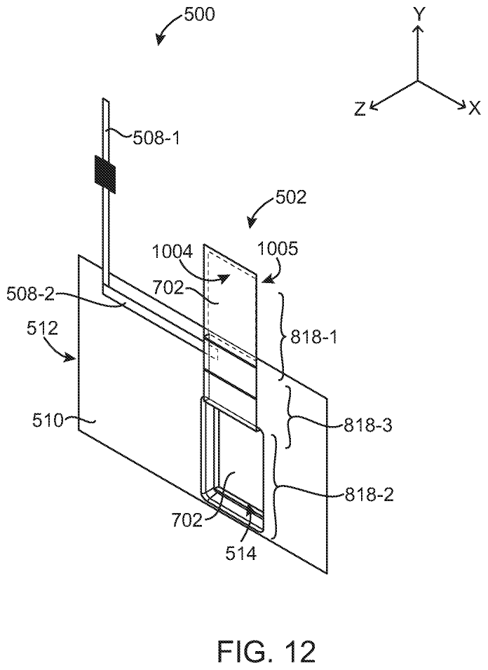

In one embodiment, the separator 702 is bonded to itself along at least a portion of an outer perimeter 1002 of the separator using a hot melt process, a welding process, a bonding process, etc. In FIG. 10, the auxiliary electrode 502 at this stage includes a first side 1004 and a second side 1005 that opposes the first side 1004. The first side 1004 includes the second surface 803 of the separator 702, which covers the carrier ion supply layers 706 in first region 818-1 proximate to first end 820 of the conductive layer 704 (not visible in FIG. 10) and the second region 818-2 proximate to the second end 821 of the conductive layer 704 (not visible in this view). In FIG. 10, the first region 818-1 is proximate to the first end 812 of the conductive tab 508-2 and the second region 818-2 is disposed away from the first end 812 of the conductive tab 508-2. The first end 812 of the conductive tab 508-2 is electrically coupled to the conductive layer 704 within the third region 818-3 of the conductive layer 704. In some embodiments, the conductive tab 508 may be extended (e.g., with the conductive tab 508-1, as shown in FIG. 11, which depicts the auxiliary electrode 502 after assembly).

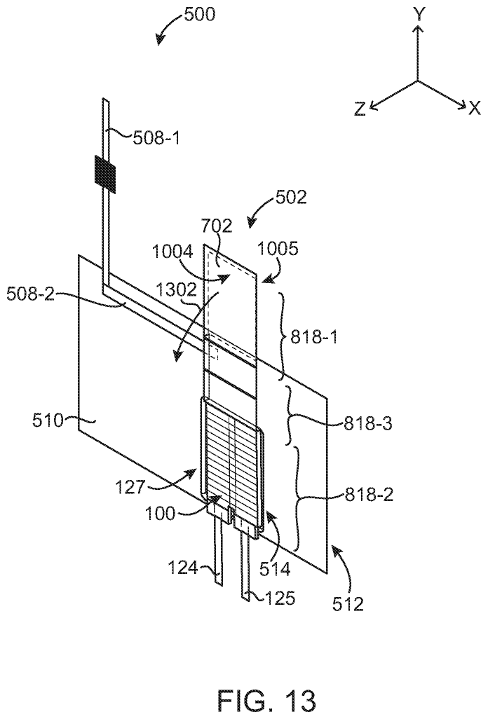

In response to fabricating the auxiliary electrode 502, performing a fabrication process for the buffer system 500 (see FIGS. 6 and 7) continues as follows. FIGS. 12-16 are perspective views of the buffer system 500 during various stages in a fabrication process. Referring to FIG. 12, the second region 818-2 of the auxiliary electrode 502 is inserted into the pouch 514 of the first enclosure layer 510, with the second side 1005 of the auxiliary electrode disposed towards the first enclosure layer 510 within the pouch 514 and the first side 1004 of the auxiliary electrode disposed away from the first enclosure layer 510 within the pouch 514. The third region 818-3 and the first region 818-1 of the auxiliary electrode 502 extend away from the pouch 514 in the direction of the Y-axis.

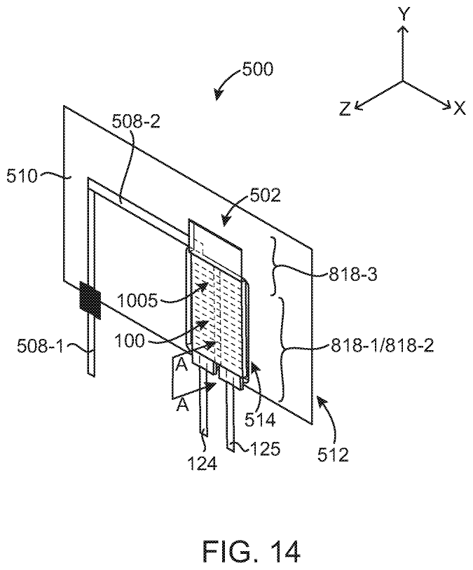

With the auxiliary electrode 502 oriented within the pouch 514 as depicted in FIG. 12, the secondary battery 100 is placed on the auxiliary electrode 502 within the pouch 514, which corresponds to the second region 818-2 of the auxiliary electrode 502 (see FIG. 13). In this embodiment, the first major surface 126 of the secondary battery 100 (see FIG. 1, not visible in FIG. 13) contacts the auxiliary electrode 502 within the pouch 514 and the second major surface 127 of the secondary battery is disposed away from the auxiliary electrode 502. The electrical terminals 124, 125 of the secondary battery 100 extend away from the pouch 514 in the direction of the Y-axis in FIG. 13, placing the electrical terminals outside of the perimeter 512 of the first enclosure layer 510. At this stage of the fabrication process for the buffer system 500, in one embodiment, an electrolyte is added to the pouch 514. In another embodiment, the separator 702 of the auxiliary electrode 502 is pre-impregnated with the electrolyte.

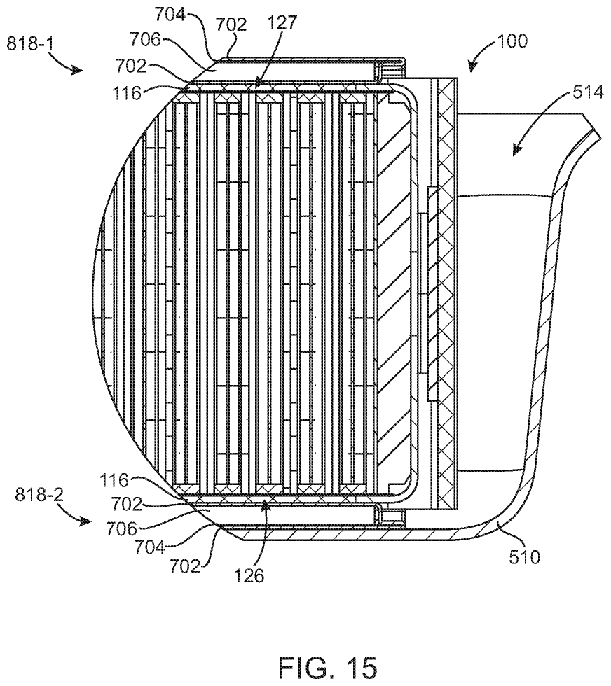

With the secondary battery 100 loaded onto the second region 818-2 of the auxiliary electrode 502 within the pouch 514, the auxiliary electrode 502 is folded in the direction of an arrow 1302 in order to position the first side 1004 of the first region 818-1 of the auxiliary electrode 502 in contact with the second major surface 127 of the secondary battery 100, the result of which is depicted in FIG. 14. In this configuration, both major surfaces 126, 127 of the secondary battery 100 (see FIG. 1) are electrochemically coupled with the carrier ion supply layers 706 of the auxiliary electrode 502, using the separator 702 (see FIGS. 7-11) and an electrolyte disposed between each of the major surfaces 126, 127 of the secondary battery 100 and the carrier ion supply layers 706.

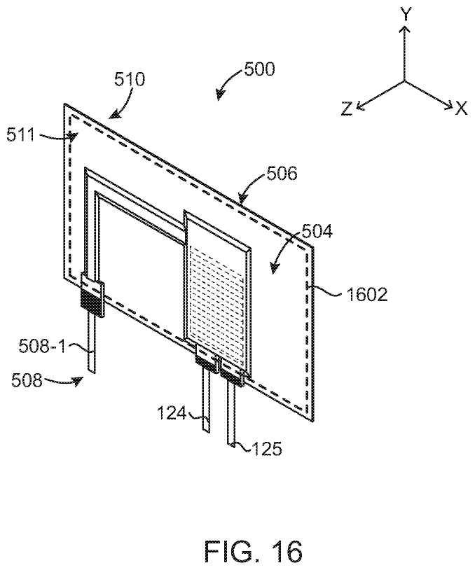

FIG. 15 is a cross-sectional view of the buffer system 500 along cut lines A-A of FIG. 14. In this view, the layers of the buffer system 500 at the pouch 514 of the first enclosure layer 510 are visible. In particular, FIG. 15 illustrates the placement of the secondary battery 100 and the auxiliary electrode 502 in the pouch 514, and specifically, from top to bottom in stacked succession, the separator 702, the conductive layer 704, one of the carrier ion supply layers 706, the separator 702, and the second major surface 127 of the secondary battery 100 at the casing 116. FIG. 15 further illustrates, from bottom to top in stacked succession, the first enclosure layer 510, the separator 702, the conductive layer 704, one of the carrier ion supply layers 706, the separator 702, and the first major surface 126 of the secondary battery 100 at the casing 116.

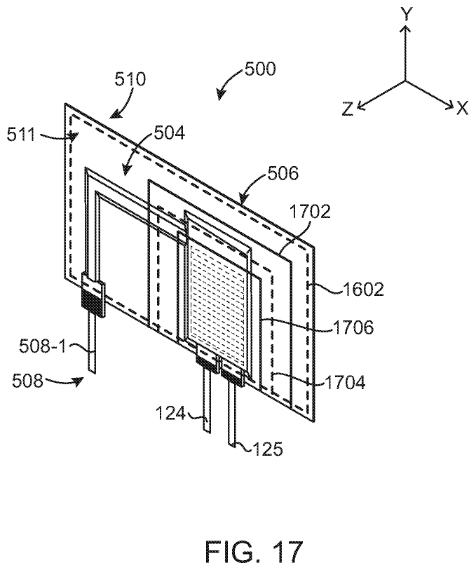

With the secondary battery 100 sandwiched by the auxiliary electrode 502 within the pouch 514 as illustrated in FIG. 15, the second enclosure layer 511 is aligned to the first enclosure layer 510, as depicted in FIG. 16. After proper placement of the second enclosure layer 511 relative to the first enclosure layer 510, the enclosure layers 510, 511 are sealed along a sealing line 1602 (denoted by the dashed line in FIG. 16) to form the enclosure 504. The enclosure layers 510, 511 may be sealed along the sealing line 1602 by welding, heat sealing, adhesive, combinations thereof, or the like. In another embodiment, the enclosure layers 510, 511 may be sealed along three sides of the sealing line 1602 creating a pocket therein. In this embodiment, the secondary battery 100 may be placed within the pocket, and the final edge of the sealing line 1602 is subsequently sealed. In one embodiment, the sealing line 1602 is sealed using a hot press, that applies a controlled temperature and pressure to the sealing line 1602 causing the enclosure layers 510, 511 to adhere or fuse together along the sealing line 1602. In another embodiment, a vacuum is applied to the secondary battery 100 during the sealing process to evacuate any excess volume occupied by air or other gas. The time for which the sealing line 1602 is subject to the hot press may be controlled and is dependent upon the materials selected for the enclosure layers 510, 511. Once sealed over the secondary battery 100, the sealed enclosure layers 510, 511 form the buffer system 500. Upon sealing, the buffer system 500 is liquid tight and/or air-tight, depending on the desired application. The electrical terminals 124 and 125 of the secondary battery 100 and the conductive tab 508-1 remain exposed and are not covered by the enclosure layers 510, 511 to allow for a subsequent buffer process to be applied to the secondary battery 100.

With the secondary battery 100 and the carrier ion supply layers 706 of the auxiliary electrode 502 (not visible in FIG. 16) electrochemically coupled together within the enclosure 504 of the buffer system 500, a carrier ion buffer process is performed on the secondary battery 100 during or after initial formation of the secondary battery 100. Generally, this carrier ion buffer process transfers carrier ions from the carrier ion supply layers 706 of the auxiliary electrode 502 into each of the first major surface 126 of the secondary battery 100 and the second major surface 127 of the secondary battery 100 (see FIG. 15). Generally, transferring the carrier ions to the secondary battery 100 from both major surfaces 126, 127 of the secondary battery 100, as depicted in FIG. 15, provides a technical benefit of distributing the forces generated by anode and/or cathode swelling more equally across the casing 116 of the secondary battery 100 as more carrier ions are loaded into the anode and/or the cathode of the secondary battery 100.

Either prior to inserting the secondary battery 100 into the buffer system 500, or after, the secondary battery 100 is charged (e.g., via the electrical terminals 124, 125) by transferring carrier ions from the cathode structures 206 of the secondary battery to the anode structures 207 of the secondary battery. Charging may be discontinued when the positive electrode 208 of the secondary battery 100 reaches its the end-of-charge design voltage. During the initial charging cycle, SEI may form on the surfaces of the anode structures 207 of the secondary battery 100. To compensate for the loss of carrier ions to SEI, and to further provide additional carrier ions to mitigate the long term secondary reactions during cycling where carrier ions are lost due to side reactions, the positive electrode 208 and/or the negative electrode 209 of the secondary battery 100 may be replenished by applying a voltage across the auxiliary electrode 502 and the cathode structures 206 and/or the anode structures 207 (e.g., via the conductive tab 508-1 of the auxiliary electrode 502 and one of the electrical terminals 124, 125) to drive carrier ions from the carrier ion supply layers 706 of the auxiliary electrode 502 to the cathode structures 206 and/or the anode structures 207 of the secondary battery 100. Once the transfer of carrier ions from the auxiliary electrode 502 to the secondary battery 100 is complete, the negative electrode 209 of the secondary battery 100 is again charged, this time with carrier ions transferred from the cathode structures 206 of the secondary battery 100 to the anode structures 207 of the secondary battery.

In one embodiment, the amount of carrier ions transferred from the auxiliary electrode 502 to the secondary battery 100 during the buffer process is about 50% of the reversable columbic capacity of the positive electrode 208 of the secondary battery 100. In other embodiments, the amount of carrier ions transferred from the auxiliary electrode 502 to the secondary battery 100 during the buffer process is about 55%, about 60%, about 65%, about 70%, about 75%, about 80%, about 85%, about 90%, about 95%, or about 100% of the reversable columbic capacity of the positive electrode 208 of the secondary battery 100. In some embodiments, the amount of carrier ions transferred from the auxiliary electrode 502 to the secondary battery 100 lies in a range of values of about 1% to about 100% of the reversable columbic capacity of the positive electrode 208 of the secondary battery 100. In one particular embodiment, the negative electrode 209 of the secondary battery 100 has about 170% of the reversable columbic capacity of the positive electrode 208 of the secondary battery 100 stored as carrier ions when the secondary battery 100 is charged, and about 70% of the reversable columbic capacity of the positive electrode 208 of the secondary battery 100 stored as carrier ions when the secondary battery 100 is discharged. An excess of carrier ions at the negative electrode 209 of the secondary battery 100 provided during the buffer process provides a technical benefit of mitigating the loss of carrier ions at the secondary battery 100 due to SEI at initial formation. Further, an excess of carrier ions at the negative electrode 209 of the secondary battery 100 provided during the buffer process provides a technical benefit of mitigating the loss of carrier ions at the secondary battery 100 due to side reactions that deplete carrier ions in the secondary battery 100 as the secondary battery 100 is cycled during use, which reduces the capacity loss of the secondary battery 100 over time.

In some embodiments, transferring carrier ions from the auxiliary electrode 502 to the secondary battery 100 may occur concurrently with an initial formation of the secondary battery 100 (e.g., during the first charge of the secondary battery 100), and/or during a subsequent charge of the secondary battery 100 after initial formation. In these embodiments, carrier ions are transferred from the positive electrode 208 of the secondary battery 100 to the negative electrode 209 of the secondary battery 100. Concurrently with or based on a temporal delay or a temporal pattern, carrier ions are transferred from the auxiliary electrode 502 to the positive electrode 208 and/or the negative electrode 209 of the secondary battery 100.

In yet another embodiment, the positive electrode 208 may be replenished with carrier ions by simultaneously transferring carrier ions from the auxiliary electrode 502 to the positive electrode 208 of the secondary battery 100, while also transferring carrier ions from the positive electrode 208 of the secondary battery 100 to the negative electrode 209 of the secondary battery 100. Referring to FIG. 6, a voltage is applied across the electrical terminals 124, 125 of the secondary battery 100, to drive carrier ions from the positive electrode 208 to the negative electrode 209 of the secondary battery 100. While the carrier ions are being transferred from the positive electrode 208 to the negative electrode 209, a voltage is applied across the conductive tab 508-1 of the auxiliary electrode 502 and the positive electrode 208 of secondary battery 100 to drive carrier ions from the auxiliary electrode 502 to the positive electrode 208 of the secondary battery 100. Thus, carrier ions are transferred from the auxiliary electrode 502 to the positive electrode 208 of the secondary battery 100 at the same time that carrier ions are being transferred from the positive electrode 208 to the negative electrode 209 of the secondary battery 100. That is, a voltage is maintained across the positive electrode 208 and the negative electrode 209 of the secondary battery 100 that is sufficient to drive carrier ions from the positive electrode 208 to the negative electrode 209 of the secondary battery 100, at the same time that a voltage is maintained across the conductive tab 508-1 of the auxiliary electrode 502 and the positive electrode 208 of the secondary battery 100 that is sufficient to drive carrier ions from the auxiliary electrode 502 to the positive electrode 208. In another embodiment, the onset of transfer of carrier ions from the auxiliary electrode 502 to the positive electrode 208 of the secondary battery 100 may commence simultaneously with onset of the transfer of carrier ions from the positive electrode 208 to the negative electrode 209 of the secondary battery 100. In one embodiment, the rate of transfer of carrier ions from the positive electrode 208 to the negative electrode 209 of the secondary battery 100 is greater than or equal to the rate of transfer of carrier ions from the auxiliary electrode 502 to the positive electrode 208 of the secondary battery 100, such that a good overall rate of transfer of carrier ions from the auxiliary electrode 502 to the negative electrode 209 of the secondary battery 100 via the positive electrode 208 can be maintained. That is, the relative rates of transfer between the positive electrode 208 and the negative electrode 209 of the secondary battery 100, and the auxiliary electrode 502 and the positive electrode 208, may be maintained such that the overall capacity of the positive electrode 208 for additional carrier ions is not exceeded. The positive electrode 208 may thus be maintained in a state where it has the ability to accept new carrier ions from the auxiliary electrode 502, which may allow for subsequent transfer of carrier ions to the negative electrode 209 of the secondary battery 100.

In one embodiment, without being limited by any particular theory, the carrier ions are transferred from the auxiliary electrode 502 to the positive electrode 208 of the secondary battery 100 as a part of the replenishment of the negative electrode 209 of the secondary battery 100 (as opposed to transferring from the auxiliary electrode 502 directly to the negative electrode 209 of the secondary battery), because the positive electrode 208 may be capable of more uniformly accepting carrier ions across the surface thereof, thus allowing the carrier ions to more uniformly participate in the transfer thereof between the positive electrode 208 and the negative electrode 209 of the secondary battery 100.

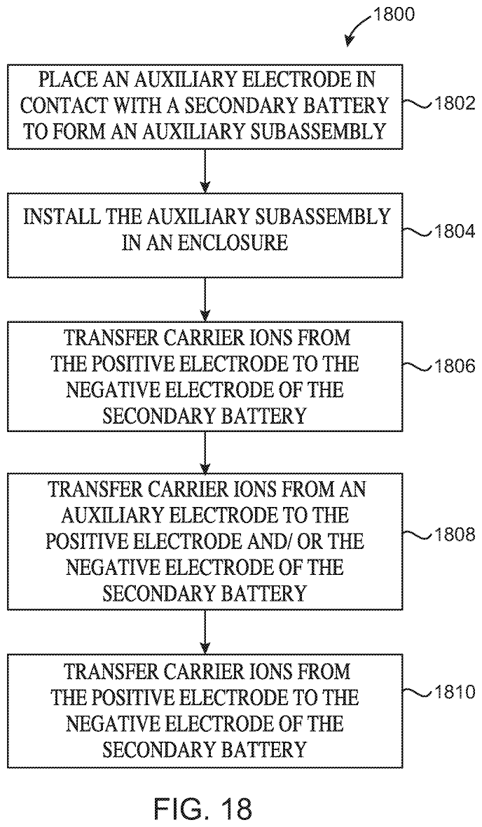

After the buffer process is performed on the secondary battery 100 utilizing the buffer system 500, the auxiliary electrode 502 may be removed from the buffer system 500 in order to improve the energy density of the secondary battery 100 in its final form. For example, after the buffer process, the carrier ion supply layers 706 (see FIG. 7) may have been removed from the conductive layer 704, having been electrochemically transferred to the secondary battery 100. Thus, the auxiliary electrode 502 may be superfluous at this point. To remove the auxiliary electrode 502 from the enclosure 504 after the buffer process is performed, the enclosure layers 510, 511 of the enclosure may be cut along cut lines 1702, illustrated in FIG. 17 as solid lines, allowing the enclosure layers 510, 511 to be peeled back proximate to the auxiliary electrode 502. The auxiliary electrode 502 is removed from the enclosure 504 of the buffer system 500, while the secondary battery 100 remains within the pouch 514 (see FIG. 12). The enclosure layers 510, 511 may then be re-sealed along a final sealing line 1704 illustrated as dashed lines to form the enclosure 504 prior to placing the secondary battery 100 in service. This re-seal may be performed using any of the previously described processes for sealing the first enclosure layer 510 and the second enclosure layer 511 together.

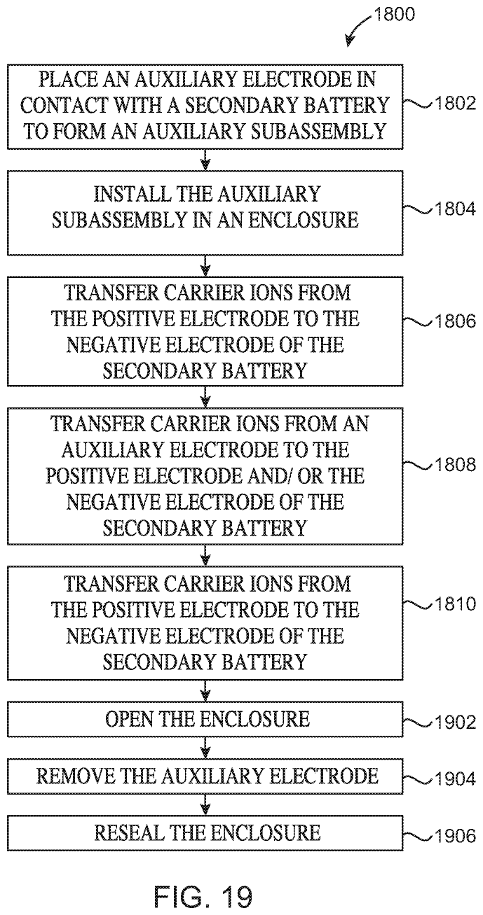

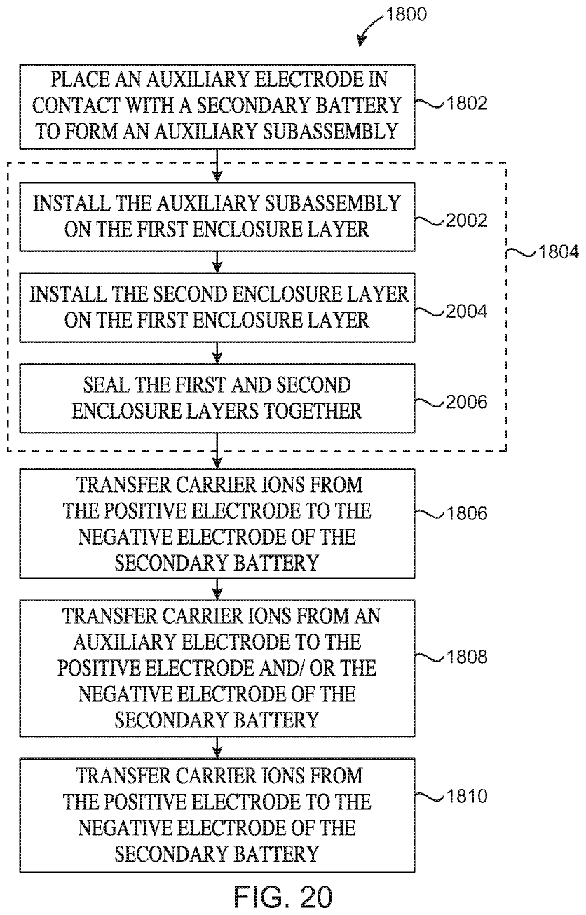

FIG. 18 is a flow chart of a method 1800 of pre-lithiating a secondary battery with carrier ions using an auxiliary electrode of an exemplary embodiment, and FIGS. 19-21 are flow charts depicting additional details of the method 1800. The method 1800 will be described with respect to the secondary battery 100, the buffer system 500, and the auxiliary electrode 502 of FIGS. 1-17, although the method 1800 may apply to other systems, not shown. The steps of the method 1800 are not all inclusive, and the method 1800 may include other steps, not shown. Further, the steps of the method 1800 may be performed in an alternate order.

In this embodiment, the secondary battery 100 (see FIG. 1) has major surfaces 126, 127 that oppose each other, and the electrical terminals 124, 125. The electrical terminals 124, 125 are coupled to one of the positive electrode 208 of the secondary battery 100 (e.g., the population of the cathode structures 206 in the secondary battery 100, as depicted in FIG. 2) and the negative electrode 209 of the secondary battery 100 (e.g., the population of the anode structures 207 in the secondary battery 100, as depicted in FIG. 2). The secondary battery 100 comprises the microporous separator layer 108 (see FIG. 2) between the negative electrode 209 and the positive electrode 208 that is permeated with an electrolyte in ionic contact with the negative electrode 209 and the positive electrode 208. The negative electrode 209 comprises the anodically active material layer 104, such as silicon or an alloy thereof, having a coulombic capacity for the carrier ions. The positive electrode 208 comprises the cathodically active material layer 106, having a coulombic capacity for the carrier ions, with a negative electrode 209 coulombic capacity exceeding a positive electrode 208 coulombic capacity.

The auxiliary electrode 502 (see FIG. 6) is placed in contact with the major surfaces 126, 127 of the secondary battery 100 to form the auxiliary subassembly 516, where the auxiliary electrode 502 includes the electrically conductive layer 704, the carrier ion supply layers 706 disposed on the conductive layer 704 that are proximate to the major surfaces 126, 127 of the secondary battery 100, the separator 702 disposed between the carrier ion supply layers 706 and the major surfaces 126, 127 of the secondary battery, and the electrically conductive tab 508 coupled to the conductive layer 704 (see step 1802 of FIG. 18, and FIGS. 12-15).

The auxiliary subassembly 516 is installed in the enclosure 504, where the electrical terminals 124, 125 of the secondary battery 100 and the electrically conductive tab 508 of the auxiliary electrode 502 electrically extend from the perimeter 506 of enclosure 504 (see step 1804, and FIG. 16).

Carrier ions are transferred from the positive electrode 208 of the secondary battery 100 to the negative electrode 209 of the secondary battery 100 to at least partially charge the secondary battery 100 by applying a potential voltage across the electrical terminals 124, 125 (see step 1806). Charging may be discontinued when the positive electrode 208 of the secondary battery 100 reaches its the end-of-charge design voltage. During the initial charging cycle, SEI may form on the internal structural surfaces of the negative electrode 209 of the secondary battery 100.

To compensate for the loss of carrier ions to SEI, and to further provide additional carrier ions to mitigate the long term secondary reactions during cycling where carrier ions are lost due to side reactions, carrier ions are transferred from the carrier ion supply layers 706 of the auxiliary electrode 502 to the positive electrode 208 and/or the negative electrode 209 of the secondary battery 100 by applying a potential voltage across the electrically conductive tab 508 of the auxiliary electrode 502 and one or more of the electrical terminals 124, 125 of the secondary battery 100 (see step 1808, FIG. 16). Generally, this carrier ion buffer process transfers carrier ions from the carrier ion supply layers 706 of the auxiliary electrode 502 into each of the first major surface 126 of the secondary battery 100 and the second major surface 127 of the secondary battery 100 (see FIG. 15). Generally, transferring carrier ions to the secondary battery 100 from both of the major surfaces 126, 127 of the secondary battery 100, as depicted in FIG. 15, provides a technical benefit of distributing the forces generated by anode and/or cathode swelling more equally across the casing 116 of the secondary battery 100 as more carrier ions are loaded into the cathode and/or the anode of the secondary battery 100.

In one embodiment, the amount of carrier ions transferred from the auxiliary electrode 502 to the secondary battery 100 is about 50% of the reversable columbic capacity of the positive electrode 208 of the secondary battery 100. In other embodiments, the amount of carrier ions transferred from the auxiliary electrode 502 to the secondary battery 100 is about 55%, about 60%, about 65%, about 70%, about 75%, about 80%, about 85%, about 90%, about 95%, or about 100% of the reversable columbic capacity of the positive electrode 208 of the secondary battery 100. In some embodiments, the amount of carrier ions transferred from the auxiliary electrode 502 to the secondary battery 100 lies in a range of values of about 1% to about 100% of the reversable columbic capacity of the positive electrode 208 of the secondary battery 100. In one particular embodiment, the negative electrode 209 of the secondary battery 100 has about 170% of the reversable columbic capacity of the positive electrode 208 of the secondary battery 100 stored as carrier ions when the secondary battery 100 is charged, and about 70% of the reversable columbic capacity of the positive electrode 208 of the secondary battery 100 stored as carrier ions when the secondary battery 100 is discharged. An excess of carrier ions at the negative electrode 209 of the secondary battery 100 provided during the buffer process provides a technical benefit of mitigating the loss of carrier ions at the secondary battery 100 due to SEI at initial formation. Further, an excess of carrier ions at the negative electrode 209 of the secondary battery 100 provided during the buffer process provides a technical benefit of mitigating the loss of carrier ions at the secondary battery 100 due to side reactions that deplete carrier ions in the secondary battery 100 as the secondary battery 100 is cycled during use, which reduces the capacity loss of the secondary battery 100 over time.

In some embodiments, transferring carrier ions from the auxiliary electrode 502 to the secondary battery 100 may occur concurrently with an initial formation of the secondary battery 100 (e.g., during the first charge of the secondary battery 100), and/or during a subsequent charge of the secondary battery 100 after initial formation. In these embodiments, carrier ions are transferred from the positive electrode 208 of the secondary battery 100 to the negative electrode 209 of the secondary battery 100. Concurrently with or based on a temporal delay or a temporal pattern, carrier ions are transferred from the auxiliary electrode 502 to the positive electrode 208 and/or the negative electrode 209 of the secondary battery 100.

Carrier ions are again transferred from the positive electrode 208 of the secondary battery 100 to the negative electrode 209 of the secondary battery 100 to charge the secondary battery 100 by applying a potential voltage across the electrical terminals 124, 125 of the secondary battery 100 until the negative electrode 209 has greater than 100% of the positive electrode 208 coulombic capacity stored as the carrier ions (see step 1810).

In yet another embodiment, the positive electrode 208 may be replenished with carrier ions by simultaneously transferring carrier ions from the auxiliary electrode 502 to the positive electrode 208 of the secondary battery 100, while also transferring carrier ions from the positive electrode 208 of the secondary battery 100 to the negative electrode 209 of the secondary battery 100. Referring to FIG. 6, a voltage is applied across the electrical terminals 124, 125 of the secondary battery 100, to drive carrier ions from the positive electrode 208 to the negative electrode 209 of the secondary battery 100. While the carrier ions are being transferred from the positive electrode 208 to the negative electrode 209, a voltage is applied across the conductive tab 508-1 of the auxiliary electrode 502 and the positive electrode 208 of secondary battery 100 to drive carrier ions from the auxiliary electrode 502 to the positive electrode 208 of the secondary battery 100. Thus, carrier ions are transferred from the auxiliary electrode 502 to the positive electrode 208 of the secondary battery 100 at the same time that carrier ions are being transferred from the positive electrode 208 to the negative electrode 209 of the secondary battery 100. That is, a voltage is maintained across the positive electrode 208 and the negative electrode 209 of the secondary battery 100 that is sufficient to drive carrier ions from the positive electrode 208 to the negative electrode 209 of the secondary battery 100, at the same time that a voltage is maintained across the conductive tab 508-1 of the auxiliary electrode 502 and the positive electrode 208 of the secondary battery 100 that is sufficient to drive carrier ions from the auxiliary electrode 502 to the positive electrode 208. In another embodiment, the onset of transfer of carrier ions from the auxiliary electrode 502 to the positive electrode 208 of the secondary battery 100 may commence simultaneously with onset of the transfer of carrier ions from the positive electrode 208 to the negative electrode 209 of the secondary battery 100. In one embodiment, the rate of transfer of carrier ions from the positive electrode 208 to the negative electrode 209 of the secondary battery 100 is greater than or equal to the rate of transfer of carrier ions from the auxiliary electrode 502 to the positive electrode 208 of the secondary battery 100, such that a good overall rate of transfer of carrier ions from the auxiliary electrode 502 to the negative electrode 209 of the secondary battery 100 via the positive electrode 208 can be maintained. That is, the relative rates of transfer between the positive electrode 208 and the negative electrode 209 of the secondary battery 100, and the auxiliary electrode 502 and the positive electrode 208, may be maintained such that the overall capacity of the positive electrode 208 for additional carrier ions is not exceeded. The positive electrode 208 may thus be maintained in a state where it has the ability to accept new carrier ions from the auxiliary electrode 502, which may allow for subsequent transfer of carrier ions to the negative electrode 209 of the secondary battery 100.

In one embodiment, without being limited by any particular theory, the carrier ions are transferred from the auxiliary electrode 502 to the positive electrode 208 of secondary battery 100 as a part of the replenishment of the negative electrode 209 of the secondary battery 100 (as opposed to transferring from the auxiliary electrode 502 directly to the negative electrode 209 of the secondary battery 100), because the positive electrode 208 may be capable of more uniformly accepting carrier ions across the surface thereof, thus allowing the carrier ions to more uniformly participate in the transfer thereof between the positive electrode 208 and the negative electrode 209 of the secondary battery 100.

In some embodiments of the method 1800, the enclosure 504 is opened (see step 1902 of FIG. 19), and the auxiliary electrode 502 is removed from the enclosure 504 (see step 1904). In response to removing the auxiliary electrode 502 from the enclosure 504, the enclosure is resealed to encapsulate the secondary battery 100 (see step 1906).

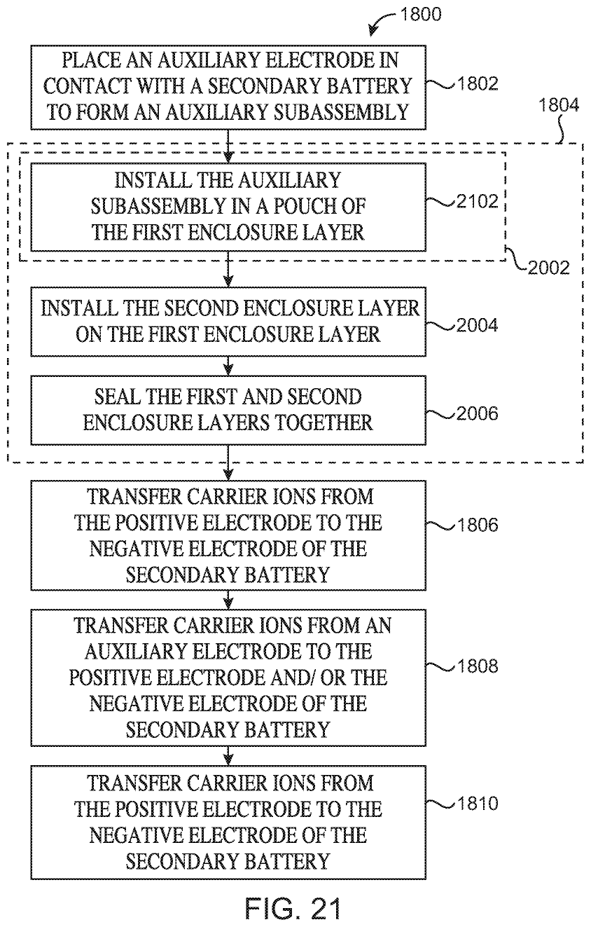

Although installing the auxiliary subassembly 516 in the enclosure 504 as previously described with respect to step 1804 detailed above, one particular embodiment comprises installing the auxiliary subassembly 516 on the first enclosure layer 510 (see step 2002 of FIG. 20). The second enclosure layer 511 is installed on the first enclosure layer 510 (see step 2004), and the first enclosure layer 510 and the second enclosure layer 511 are sealed together along the sealing line 1602 to form the enclosure 504 (see step 2006).

The enclosure layers 510, 511 may be sealed along the sealing line 1602 (see FIG. 16) by welding, heat sealing, adhesive, combinations thereof, or the like. In another embodiment, the enclosure layers 510, 511 may be sealed along three sides of the sealing line 1602 creating a pocket therein. In this embodiment, the secondary battery 100 may be placed within the pocket, and the final edge of the sealing line 1602 is subsequently sealed. In one embodiment, the sealing line 1602 is sealed using a hot press, that applies a controlled temperature and pressure to the sealing line 1602 causing the enclosure layers 510, 511 to adhere or fuse together along the sealing line 1602. In another embodiment, a vacuum is applied to the secondary battery 100 during the sealing process to evacuate any excess volume occupied by air or other gas. The time for which the sealing line 1602 is subject to the hot press may be controlled and is dependent upon the materials selected for the enclosure layers 510, 511. Once sealed over the secondary battery 100, the sealed enclosure layers 510, 511 form the buffer system 500. Upon sealing, the buffer system 500 is liquid tight and/or air-tight, depending on the desired application. The electrical terminals 124, 125 of the secondary battery 100 and the conductive tab 508 remain exposed and are not covered by the enclosure layers 510, 511.

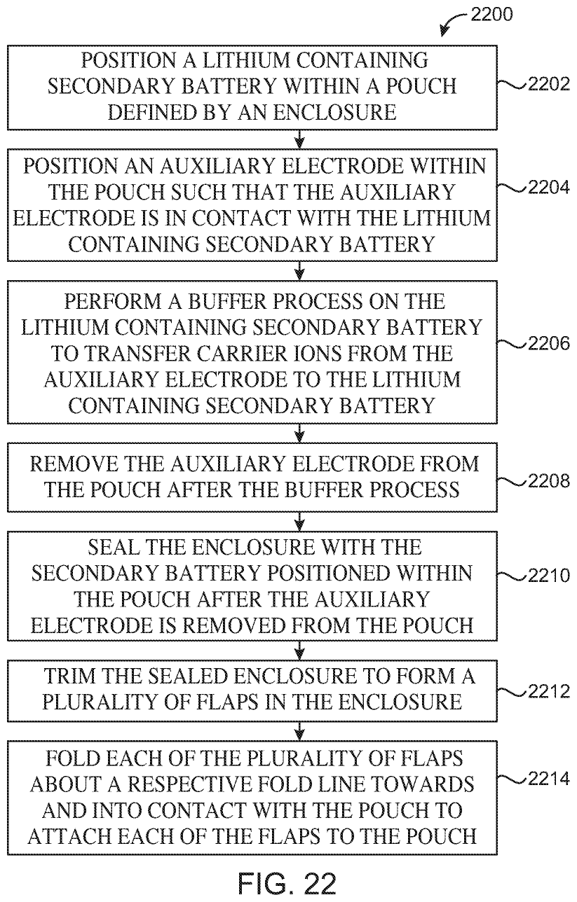

In embodiments where the first enclosure layer 510 includes the pouch 514, installing the auxiliary subassembly 516 within the enclosure 504 initially comprises placing the auxiliary subassembly 516 within the pouch 514 (see step 2102 of FIG. 21). In some embodiments, an electrolyte is added to the pouch 514 (e.g., either before or after installing the auxiliary subassembly 516 in the pouch 514), with the enclosure 504 formed subsequent thereto by sealing the first enclosure layer 510 and the second enclosure layer 511 together along the sealing line 1602.

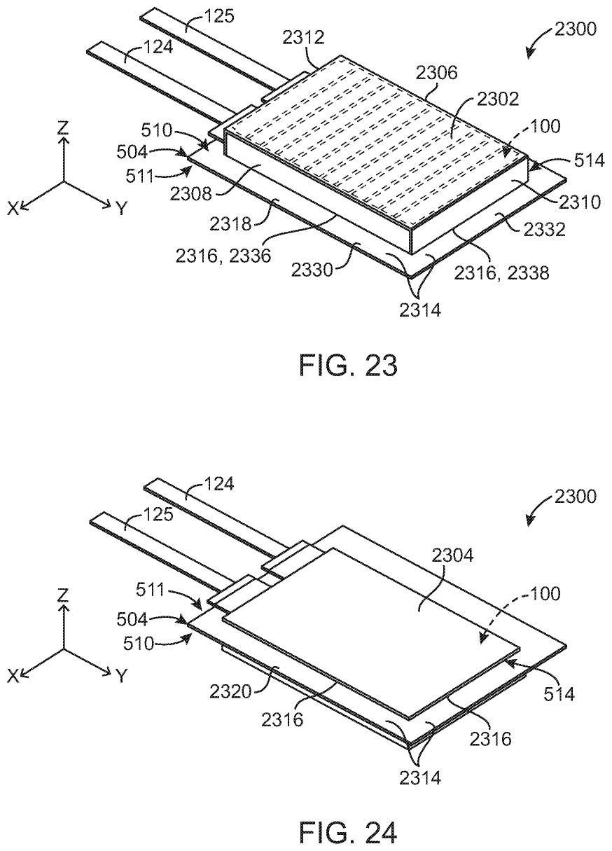

FIG. 22 is a flow chart of an example method 2200 of forming a secondary battery assembly, for example, to prepare the secondary battery assembly for end use following a pre-lithiation or buffer process. The method 2200 will be described with respect to the secondary battery 100, the buffer system 500, and the auxiliary electrode 502 of FIGS. 1-17, although the method 2200 may apply to other systems, not shown. The steps of the method 2200 are not all inclusive, and the method 2200 may include other steps, not shown. Further, the steps of the method 2200 may be performed in an alternate order.

In the example method 2200, the secondary battery 100 is positioned 2202 within the pouch 514 defined by the enclosure 504, and the auxiliary electrode 502 is positioned 2204 within the pouch 514 such that the auxiliary electrode 502 is in contact with the secondary battery 100. A buffer process, such as the buffer or pre-lithiation processes described herein, is performed 2206 on the lithium containing secondary battery to transfer carrier ions from the auxiliary electrode 502 to the lithium containing secondary battery 100.

After the buffer process is performed 2206, the auxiliary electrode 502 is removed 2208 from the pouch 514. As described above, for example, the enclosure layers 510, 511 of the enclosure 504 may be cut or separated along separation lines 1702 (FIG. 17) following the buffer or pre-lithiation process, and the enclosure layers 510, 511 may be peeled back proximate to the auxiliary electrode 502 to remove 2208 the auxiliary electrode 502 from the pouch 514 of the enclosure 504. The secondary battery 100 may remain within the pouch 514 or be repositioned in the pouch 514 after the auxiliary electrode 502 is removed 2208.

The enclosure 504 may then be sealed (or resealed) 2210 with the secondary battery 100 positioned within the pouch 514 after the auxiliary electrode 502 is removed from the pouch 514. For example, the enclosure layers 510, 511 may be sealed 2210 along the final sealing line 1704 using any of the previously described processes for sealing the first enclosure layer 510 and the second enclosure layer 511 together. The sealed enclosure 504 may then be trimmed or cut 2212 along one or more final cut lines 1706, illustrated in FIG. 17 as solid lines, such that a plurality of flaps is formed from the enclosure 504, where each flap extends outward from the pouch 514 at a respective fold line. The enclosure 504 may be trimmed 2212 along the one or more final cut lines 1706 (FIG. 17) by die cutting, rotary cutting, reciprocal cutting, laser cutting, fluid jet cutting, and combinations thereof. As described further herein, each of the flaps remaining after the final trim 2212 may be folded 2214 about a respective fold line towards and into contact with the pouch 514 to attach each of the flaps to the pouch 514. In some embodiments, for example, each of the plurality of flaps are folded into contact with and connected or secured to the pouch 514 to reduce the footprint of and provide a compact package of the secondary battery assembly for end use. In some embodiments, an adhesive may be applied to each of the flaps and/or a portion of the pouch 514, and each flap may be folded about a respective fold line into contact with the pouch 514 to adhere each of the flaps to the pouch 514.

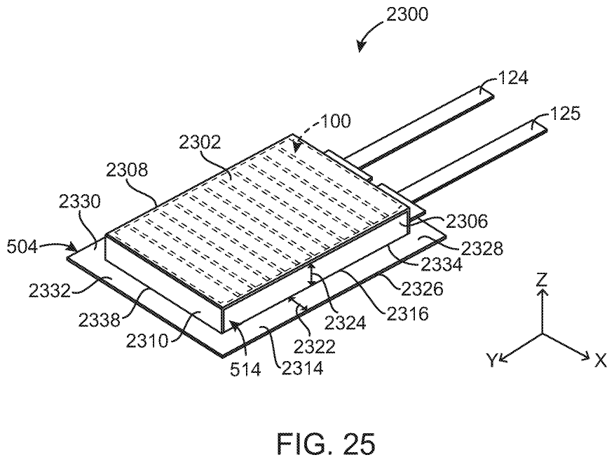

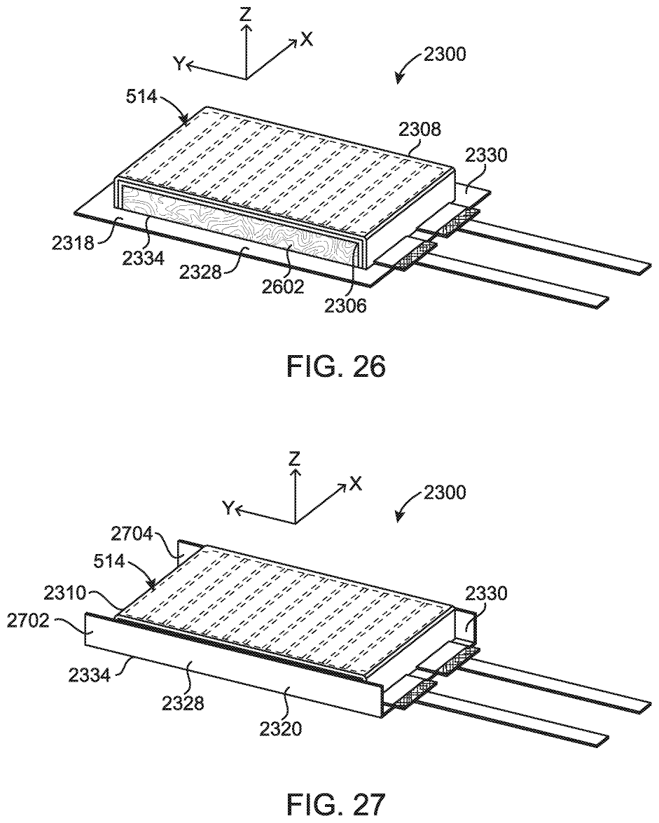

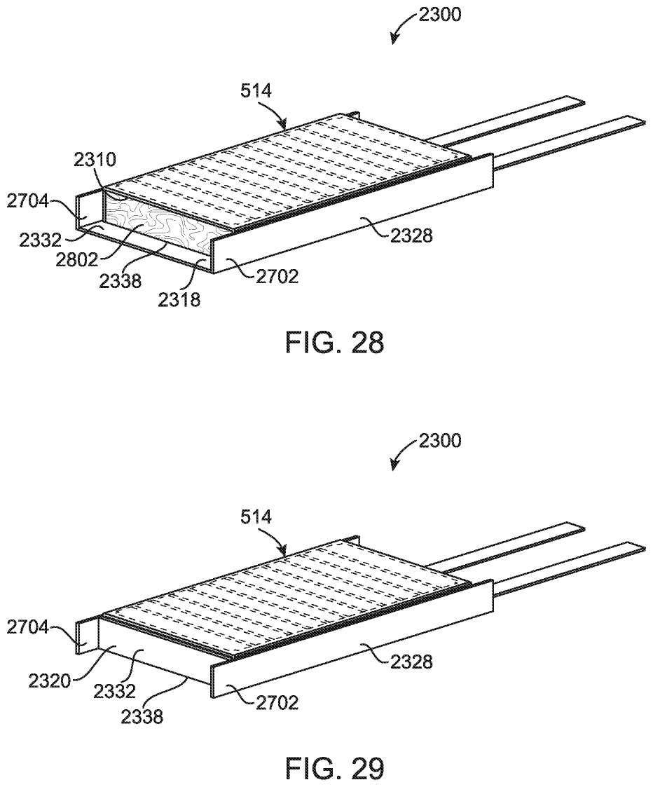

FIGS. 23 and 24 are front and rear perspective views, respectively, of an example secondary battery assembly 2300 at an intermediate stage of formation (e.g., after the sealing 2210 and trimming 2212 steps, but prior to the flap folding step 2214 of the method 2200 of FIG. 22). FIG. 25 is another front perspective view of the secondary battery assembly 2300. The secondary battery assembly 2300 includes the secondary battery 100 and the enclosure 504, and is illustrated with the secondary battery 100 positioned within the pouch 514 of the enclosure 504 in FIGS. 23-25.

In this embodiment, the pouch 514 is shaped as a rectangular prism, and includes a planar, rectangular base 2302, a planar, rectangular cover 2304 (FIG. 24) spaced from and positioned opposite the base 2302 (in the Z-direction as illustrated in FIGS. 23 and 24), a first sidewall 2306 extending from the base 2302 to the cover 2304, a second sidewall 2308 positioned opposite and spaced from the first sidewall 2306 (in the X-direction as illustrated in FIGS. 23 and 24) and extending from the base 2302 to the cover 2304, a first end wall 2310 extending from the first sidewall 2306 to the second sidewall 2308 and from the base 2302 to the cover 2304, and a second end wall 2312 positioned opposite and spaced from the first end wall 2310 (in the Y-direction as illustrated in FIGS. 23 and 24) and extending from the first sidewall 2306 to the second sidewall 2308 and from the base 2302 to the cover 2304. The electrical terminals 124, 125 of the secondary battery 100 extend through and outward from the second end wall 2312 in the illustrated embodiment. In this embodiment, the base 2302 and each of the first sidewall 2306, the second sidewall 2308, the first end wall 2310, and the second end wall 2312 are defined by the first enclosure layer 510, and the cover 2304 is defined by the second enclosure layer 511. It should be understood that elements of the pouch 514 may be formed from either the first enclosure layer 510 or the second enclosure layer 511 in other embodiments. Moreover, although the pouch 514 and each of the base 2302, cover 2304, sidewalls 2306, 2308, and end walls 2310, 2312 are rectangular in the illustrated embodiment, the pouch 514 and elements thereof may be shaped other than rectangular in other embodiments.

As shown in FIGS. 23-25, the enclosure 504 includes a plurality of flaps 2314 extending outward from the pouch 514 at respective fold lines 2316 following the sealing 2210 and trimming 2212 steps of the method 2200 (FIG. 22). The fold lines 2316 may include unperforated and uncreased lines, such as a line along which one of the flaps 2314 emanates from or joins the pouch 514 and about which the flap 2314 is folded, for example, to attach the flap 2314 to the pouch 514, as described further herein. A fold line 2316, as used herein, need not be creased, perforated, scored, or otherwise delineated to be considered a fold line. Each flap 2314 includes a first surface 2318 (FIG. 23) and an opposing second surface 2320 (FIG. 24). The first surface 2318 faces generally towards the pouch 514 and away from the cover 2304, and the second surface 2320 faces generally away from the pouch 514 (in the Z-direction, as illustrated in FIG. 24). In the illustrated embodiment, the first surface 2318 of each flap 2314 is defined by the first enclosure layer 510, and the second surface 2320 of each flap 2314 is defined by the second enclosure layer 511.

The plurality of flaps 2314 is formed during the sealing 2210 and/or trimming 2212 steps described above. More specifically, the size and shape of each flap 2314 may be set when the enclosure 504 is sealed and trimmed following removal of the auxiliary electrode 502. In the illustrated embodiment, each of the flaps 2314 is rectangular in shape, although other embodiments may have flaps shaped other than rectangular. In some embodiments, the step of trimming 2212 the enclosure 504 may include trimming the enclosure 504 such that each of the flaps 2314 has a width 2322 (FIG. 25), measured from the respective fold line 2316 to a free edge 2326 of the flap 2314 (i.e., in the X-direction or the Y-direction, as illustrated in FIG. 25), that is less than or equal to a height 2324 of the secondary battery 100 and/or the pouch 514, measured from the base 2302 to the cover 2304 (i.e., in the Z-direction as illustrated in FIG. 25), such that the flaps 2314 do not extend vertically (in the Z-direction, as illustrated in FIG. 25) beyond the pouch 514 when the flaps 2314 are folded into contact with the pouch 514.

In the illustrated embodiment, the secondary battery assembly 2300 includes a first side flap 2328, a second side flap 2330, and an end flap 2332, although other embodiments may include additional or alternative flaps. The first side flap 2328 extends outward (in the X-direction as illustrated in FIGS. 23-25) from the pouch first sidewall 2306 at a first fold line 2334, the second side flap 2330 extends outward (in the X-direction as illustrated in FIGS. 23-25) from the pouch second sidewall 2308 at a second fold line 2336, and the end flap 2332 extends outward (in the Y-direction as illustrated in FIGS. 23-25) from the pouch first end wall 2310 at a third fold line 2338.

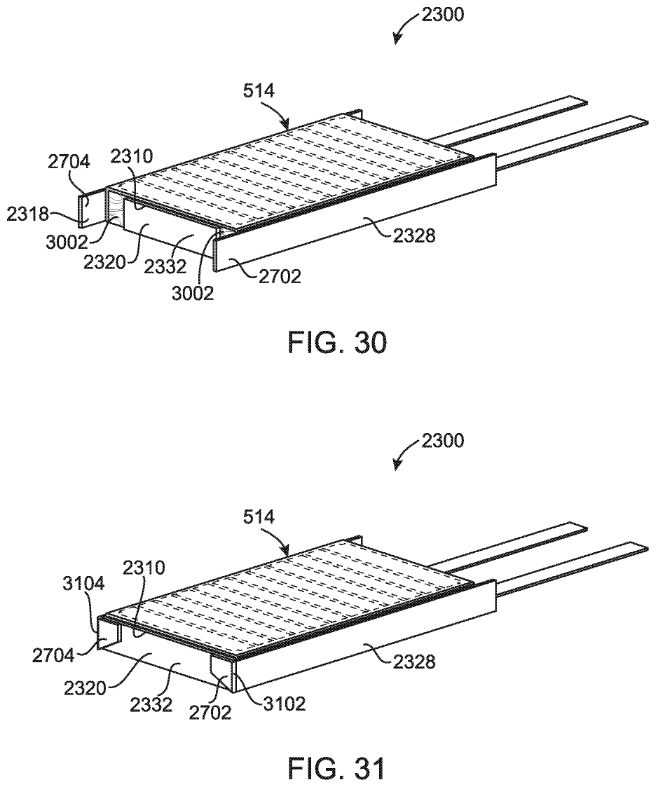

FIGS. 26-31 illustrate steps in an exemplary method of forming the secondary battery assembly 2300. These steps may be performed immediately following the sealing 2210 and trimming 2212 steps described with reference to FIG. 22, or after one or more intermediate steps are performed on the secondary battery assembly 2300. Moreover, the steps illustrated in FIGS. 26-31 may be performed sequentially, in the order shown, or one or more steps may be performed in a different order.

As shown in FIG. 26, a bonding agent 2602 is applied to at least one of the first surface 2318 of the first side flap 2328 and the pouch first sidewall 2306, and to at least one of the first surface 2318 of the second side flap 2330 and the pouch second sidewall 2308. In the illustrated embodiment, the bonding agent 2602 is applied to the pouch first sidewall 2306 and to the pouch second sidewall 2308, although the bonding agent 2602 may be applied to the first side flap 2328 and/or the second side flap 2330 in addition to or alternatively to applying the bonding agent 2602 to the pouch 514. In some embodiments, for example, the bonding agent 2602 is applied to each of the first surface 2318 of the first side flap 2328 and to the first surface 2318 of the second side flap 2330, instead of the bonding agent 2602 being applied to the first and second sidewalls 2306, 2308 of the pouch 514. Examples of suitable bonding agents include, for example and without limitation, adhesive strips (e.g., tape), liquid adhesives, epoxies, resins, and combinations thereof. In one example embodiment, the bonding agent 2602 includes adhesive strips.

After the bonding agent 2602 is applied, the first side flap 2328 is folded about the first fold line 2334 towards and into contact with the pouch first sidewall 2306 to connect the first side flap 2328 to the pouch first sidewall 2306, and the second side flap 2330 is folded about the second fold line 2336 towards and into contact with the pouch second sidewall 2308 to connect the second side flap 2330 to the pouch second sidewall 2308, as shown in FIGS. 26 and 27. In some embodiments, the first side flap 2328 and/or the second side flap 2330 may initially be only partially folded towards the pouch 514 (e.g., not into contact with the pouch 514), and folded into contact with and/or attached to the pouch 514 during one or more subsequent steps (e.g., a compression step, as described further herein).

As shown in FIG. 27, after the first and second side flaps 2328, 2330 are folded towards and, optionally, into contact with the pouch 514, a portion of the first side flap 2328 extends beyond the pouch first end wall 2310 (in the Y-direction as illustrated in FIG. 27) to define a first tab 2702, and a portion of the second side flap 2330 extends beyond the pouch first end wall 2310 (in the Y-direction as illustrated in FIG. 27) to define a second tab 2704.

As shown in FIG. 28, a bonding agent 2802 is also applied to at least one of the first surface 2318 of the end flap 2332 and the first end wall 2310 of the pouch 514. In the illustrated embodiment, the bonding agent 2802 is applied to the pouch first end wall 2310, although the bonding agent 2802 may be applied to the end flap 2332 in addition to or alternatively to applying the bonding agent 2802 to the pouch 514. In some embodiments, for example, the bonding agent 2802 is applied to the first surface 2318 of the end flap 2332, instead of the bonding agent 2802 being applied to the first end wall 2310 of the pouch 514. The bonding agent 2802 applied to the end flap 2332 and/or the first end wall 2310 of the pouch 514 may include any of the above-described bonding agents with reference to the bonding agent 2602 (FIG. 26). The bonding agent 2802 applied to the end flap 2332 and/or the first end wall 2310 of the pouch 514 may be the same as or different from the bonding agent 2602 applied to the first and second sidewalls 2306, 2308 of the pouch 514 and/or the first and second side flaps 2328, 2330. In one example embodiment, the bonding agent 2802 includes an adhesive strip.

After the bonding agent 2802 is applied to the end flap 2332 and/or the pouch first end wall 2310, the end flap 2332 is folded about the third fold line 2338 towards and into contact with the pouch first end wall 2310 to connect the end flap 2332 to the pouch first end wall 2310, as shown in FIGS. 28 and 29. In some embodiments, the end flap 2332 may initially be only partially folded towards the pouch 514 (e.g., not into contact with the pouch 514), and folded into contact with and/or attached to the pouch 514 during one or more subsequent steps (e.g., a compression step, as described further herein).

When the end flap 2332 is folded towards and, optionally, into contact with the first end wall 2310 of the pouch 514, a portion of the first and second tabs 2702, 2704 may be folded along with the end flap 2332 because the end flap 2332 and first and second tabs 2702, 2704 are connected. As a result, an edge of each of the tabs 2702, 2704 may be oriented at an oblique angle relative to the other edges of the tabs 2702, 2704, as shown, for example, in FIG. 31. Because of this, these tabs 2702, 2704 may colloquially be referred to as “bat ears”.

As shown in FIG. 30, a bonding agent 3002 is also applied to at least one of the second surface 2320 of the end flap 2332 and the first surface 2318 of each of the first and second tabs 2702, 2704. In this embodiment, the bonding agent 3002 is applied after the first side flap 2328, the second side flap 2330, and the end flap 2332 are folded towards and, optionally, into contact with the pouch 514, although in other embodiments the bonding agent 3002 may be applied prior to one or more of the first side flap 2328, the second side flap 2330, and the end flap 2332 being folded towards and, optionally, into contact with the pouch 514. In the illustrated embodiment, the bonding agent 3002 is applied to second surface 2320 of the end flap 2332, although the bonding agent 3002 may be applied to the first tab 2702 and/or the second tab 2704 (e.g., the first surface 2318 of the first tab 2702 and/or the second tab 2704) in addition to or alternatively to applying the bonding agent 3002 to the end flap 2332. In some embodiments, for example, the bonding agent 3002 is applied to the first surface 2318 of the first tab 2702 and the first surface 2318 of the second tab 2704, instead of the bonding agent 3002 being applied to the second surface 2320 of the end flap 2332. The bonding agent 3002 applied to the end flap 2332 and/or the first and second tabs 2702, 2704 may include any of the above-described bonding agents with reference to the bonding agent 2602 (FIG. 26) and the bonding agent 2802 (FIG. 28). The bonding agent 3002 applied to the end flap 2332 and/or the first and second tabs 2702, 2704 may be the same as or different from the bonding agents 2602, 2802 applied to the other flaps 2314 and/or the pouch 514. In one example embodiment, the bonding agent 3002 includes adhesive strips.

After the bonding agent 3002 is applied, the first tab 2702 is folded about a fourth fold line 3102 towards and into contact with the second surface 2320 of the end flap 2332 to connect the first tab 2702 to the end flap 2332, and the second tab 2704 is folded about a fifth fold line 3104 towards and into contact with the second surface 2320 of the end flap 2332 to connect the second tab 2704 to the end flap 2332, as shown in FIG. 31. In some embodiments, the first tab 2702 and/or the second tab 2704 may initially be only partially folded towards the end flap 2332 (e.g., not into contact with the end flap 2332), and folded into contact with and/or attached to the end flap 2332 during one or more subsequent steps (e.g., a compression step, as described further herein).

In some embodiments, the secondary battery assembly 2300 may be subjected to one or more compression and/or thermal processing steps to facilitate maintaining engagement between the flaps 2314 and the pouch 514. For example, the secondary battery assembly 2300 may be compressed and/or heated (simultaneously or in sequential steps) after one or more of the flaps 2314 are folded towards and, optionally, into contact with the pouch 514 to facilitate adhesion between the one or more flaps 2314 and the pouch 514, and/or to reduce or relieve internal stress or strain in the flaps 2314 (specifically within the material of the enclosure 504) resulting from deformation of the flaps 2314 during folding.

In some embodiments, for example, the first side flap 2328 is compressed against the pouch first sidewall 2306 and the second side flap 2330 is compressed against the pouch second sidewall 2308 after the first side flap 2328 is folded towards and, optionally, into contact with the pouch first sidewall 2306 and the second side flap 2330 is folded towards and, optionally, into contact with the pouch second sidewall 2308. The compressive force or pressure used to compress the first side flap 2328 against the pouch first sidewall 2306 and the second side flap 2330 against the pouch second sidewall 2308 may be any suitable force or pressure that facilitates maintaining engagement or connection between the first and second side flaps 2328, 2330 and the pouch 514. In some embodiments, the first and second side flaps 2328, 2330 are compressed against the pouch first sidewall 2306 and the pouch second sidewall 2308, respectively, by applying a compressive force across the pouch first sidewall 2306 and the pouch second sidewall 2308 equal to a pressure of at least 5 pounds per square inch (psi), at least 8 psi, at least 10 psi, at least 15 psi, at least 20 psi, at least 25 psi, at least 30 psi, at least 35 psi, between 5 psi and 50 psi, between 5 psi and 20 psi, between 10 psi and 40 psi, between 5 psi and 15 psi, or between 20 psi and 40 psi.

The first side flap 2328 and the second side flap 2330 may be compressed against the pouch 514 simultaneously or sequentially. Moreover, the secondary battery assembly 2300 may be heated prior to, during, or after the first side flap 2328 and the second side flap 2330 being compressed against the pouch 514. In one example embodiment, the first side flap 2328 is compressed against the pouch first sidewall 2306 and the second side flap 2330 is compressed against the pouch second sidewall 2308 while the secondary battery assembly 2300 is heated at a first compression temperature for a first compression time. The first compression temperature may be, for example and without limitation, in the range of 50° C. to 150° C., in the range of 70° C. to 150° C., in the range of 90° C. to 150° C., in the range of 90° C. to 140° C., in the range of 100° C. to 150° C., in the range of 90° C. to 130° C., in the range of 100° C. to 140° C., in the range of 110° C. to 150° C., in the range of 90° C. to 120° C., in the range of 100° C. to 130° C., in the range of 110° C. to 140° C., or in the range of 120° C. to 150° C. The first compression time may be, for example and without limitation, in the range of 10 seconds to 60 seconds, in the range of 10 seconds to 40 seconds, in the range of 20 seconds to 50 seconds, in the range of 30 seconds to 60 seconds, in the range of 10 seconds to 30 seconds, in the range of 15 seconds to 35 seconds, in the range of 20 seconds to 40 seconds, or in the range of 25 seconds to 45 seconds.

Additionally or alternatively, the end flap 2332, the first tab 2702, and the second tab 2704 may be compressed against the pouch first end wall 2310 after the end flap 2332 is folded towards and, optionally, into contact with the pouch first end wall 2310, and the first and second tabs 2702, 2704 are folded towards and, optionally, into contact with the end flap 2332. The compressive force or pressure used to compress the end flap 2332, the first tab 2702, and the second tab 2704 against the pouch first end wall 2310 may be any suitable force or pressure that facilitates maintaining engagement or connection between the end flap 2332 and the pouch first end wall 2310, and/or between the first and second tabs 2702, 2704 and the end flap 2332. In some embodiments, the end flap 2332 and the first and second tabs 2702, 2704 are compressed against the pouch first end wall 2310 by applying a compressive force across the pouch first end wall 2310 equal to a pressure of at least 2.5 psi, at least 3 psi, at least 4 psi, at least 5 psi, at least 10 psi, at least 15 psi, at least 20 psi, between 2.5 psi and 40 psi, between 2.5 psi and 30 psi, between 2.5 psi and 25 psi, between 3 psi and 30 psi, between 3 psi and 25 psi, between 4 psi and 40 psi, between 4 psi and 25 psi, between 5 psi and 40 psi, between 5 psi and 30 psi, between 5 psi and 25 psi, between 10 psi and 50 psi, between 10 psi and 40 psi, between 10 psi and 30 psi, between 10 psi and 25 psi, between 15 psi and 30 psi, or between 20 psi and 35 psi.

The end flap 2332, the first tab 2702, and the second tab 2704 may be compressed against the pouch first end wall 2310 simultaneously or sequentially. Moreover, the secondary battery assembly 2300 may be heated prior to, during, or after the end flap 2332, the first tab 2702, and the second tab 2704 being compressed against the pouch 514. In one example embodiment, the end flap 2332, the first tab 2702, and the second tab 2704 are compressed against the pouch first end wall 2310 while the secondary battery assembly 2300 is heated at a second compression temperature for a second compression time. The second compression temperature may be, for example and without limitation, in the range of 50° C. to 150° C., in the range of 70° C. to 150° C., in the range of 90° C. to 150° C., in the range of 90° C. to 140° C., in the range of 100° C. to 150° C., in the range of 90° C. to 130° C., in the range of 100° C. to 140° C., in the range of 110° C. to 150° C., in the range of 90° C. to 120° C., in the range of 100° C. to 130° C., in the range of 110° C. to 140° C., or in the range of 120° C. to 150° C. The second compression time may be, for example and without limitation, in the range of 10 seconds to 60 seconds, in the range of 10 seconds to 40 seconds, in the range of 20 seconds to 50 seconds, in the range of 30 seconds to 60 seconds, in the range of 10 seconds to 30 seconds, in the range of 15 seconds to 35 seconds, in the range of 20 seconds to 40 seconds, or in the range of 25 seconds to 45 seconds.

The compression and thermal processing steps described above may be performed on the secondary battery assembly 2300 using any suitable known compression fixture(s) and heating system(s). For example, a suitable compression fixture may include a pair of plates oriented parallel to one another, where at least one of the plates is fixed to a drive mechanism to move the plate towards and away from the other plate to apply a compressive load to an object positioned between the plates. The compression fixture or a portion thereof may be enclosed or positioned within a temperature-controlled environment such that the object compressed by the compression fixture may be heated at a desired temperature. Additionally, in some embodiments, the secondary battery assembly 2300 may be positioned and secured within a clamp, vice, or other compressive device prior to being subjected to the compression and/or thermal processing steps described herein. For example, the secondary battery assembly 2300 may be secured within a clamp that applies pressure in a direction orthogonal to a direction of the compressive force applied during the compression process to prevent or inhibit deformation of the secondary battery assembly 2300 in the direction orthogonal to the direction of the compressive force. In some embodiments, for example, the secondary battery assembly 2300 is placed in a clamp that applies a compressive force against the base 2302 and the cover 2304 (i.e., in the Z-direction, as illustrated in FIGS. 23-25), prior to the secondary battery assembly 2300 being subjected to the compression processing steps described herein.

The following embodiments are provided to illustrate various aspects of the present disclosure. The following embodiments are not intended to be limiting and therefore, the present disclosure further supports other aspects and/or embodiments not specifically provided below.
Embodiment 1: A method of forming a lithium containing secondary battery including a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure, the method comprising positioning the lithium containing secondary battery within a pouch defined by an enclosure, trimming the enclosure to form a plurality of flaps, the plurality of flaps including a first side flap extending from the pouch at a first fold line, a second side flap extending from the pouch at a second fold line, and an end flap extending from the pouch at a third fold line, attaching the first side flap and the second side flap to the pouch by folding each of the first and second side flaps about the respective first and second fold lines towards and into contact with the pouch, wherein a portion of the first side flap extends beyond the pouch to define a first tab and a portion of the second side flap extends beyond the pouch to define a second tab, attaching the end flap to the pouch by folding the end flap about the third fold line towards and into contact with the pouch, and attaching the first tab and the second tab to the end flap by folding each of the first tab and the second tab towards and into contact with the end flap.
Embodiment 2: The method of embodiment 1, wherein attaching the first side flap and the second side flap to the pouch comprises applying a bonding agent to at least one of the first side flap and the pouch, and to at least one of the second side flap and the pouch, folding the first side flap about the first fold line towards the pouch, folding the second side flap about the second fold line towards the pouch, and compressing the first and second side flaps against the pouch.
Embodiment 3: The method of embodiment 2, wherein compressing the first and second side flaps against the pouch comprises compressing the first and second side flaps against the pouch while heated at a temperature in a range of 50° C. to 150° C., in a range of 70° C. to 150° C., in a range of 90° C. to 150° C., in a range of 90° C. to 140° C., in a range of 100° C. to 150° C., in a range of 90° C. to 130° C., in a range of 100° C. to 140° C., in a range of 110° C. to 150° C., in a range of 90° C. to 120° C., in a range of 100° C. to 130° C., in a range of 110° C. to 140° C., or in a range of 120° C. to 150° C.
Embodiment 4: The method of embodiment 3, wherein compressing the first and second side flaps against the pouch comprises compressing the first and second side flaps against the pouch while heated at the temperature for a time in a range of 10 seconds to 60 seconds, in a range of 10 seconds to 40 seconds, in a range of 20 seconds to 50 seconds, in a range of 30 seconds to 60 seconds, in a range of 10 seconds to 30 seconds, in a range of 15 seconds to 35 seconds, in a range of 20 seconds to 40 seconds, or in a range of 25 seconds to 45 seconds.
Embodiment 5: The method of any previous embodiment, wherein attaching the end flap to the pouch comprises applying a bonding agent to at least one of the end flap and the pouch, folding the end flap about the third fold line towards the pouch, compressing the end flap, the first tab, and the second tab against the pouch after the first tab and the second tab are folded towards and into contact with the end flap.
Embodiment 6: The method of any previous embodiment, wherein attaching the first tab and the second tab to the end flap comprises applying, after the end flap is folded towards and into contact with the pouch, a bonding agent to at least one of the end flap and each of the first and second tabs, folding the first and second tabs towards and into contact with the end flap, compressing the end flap, the first tab, and the second tab against the pouch.
Embodiment 7: The method of embodiment 6, wherein compressing the end flap, the first tab, and the second tab against the pouch comprises compressing the end flap, the first tab, and the second tab against the pouch while heated at a temperature in a range of 50° C. to 150° C., in a range of 70° C. to 150° C., in a range of 90° C. to 150° C., in a range of 90° C. to 140° C., in a range of 100° C. to 150° C., in a range of 90° C. to 130° C., in a range of 100° C. to 140° C., in a range of 110° C. to 150° C., in a range of 90° C. to 120° C., in a range of 100° C. to 130° C., in a range of 110° C. to 140° C., or in a range of 120° C. to 150° C.
Embodiment 8: The method of embodiment 7, wherein compressing the end flap, the first tab, and the second tab against the pouch comprises compressing the end flap, the first tab, and the second tab against the pouch while heated at the temperature for a time in a range of 10 seconds to 60 seconds, in a range of 10 seconds to 40 seconds, in a range of 20 seconds to 50 seconds, in a range of 30 seconds to 60 seconds, in a range of 10 seconds to 30 seconds, in a range of 15 seconds to 35 seconds, in a range of 20 seconds to 40 seconds, or in a range of 25 seconds to 45 seconds.
Embodiment 9: The method of any previous embodiment, wherein trimming the enclosure comprises trimming the enclosure such that each flap of the plurality of flaps has a width, measured from the respective fold line to a free edge of the flap, less than or equal to a height of the pouch such that when each of the plurality of flaps is folded into contact with the pouch, none of the plurality of flaps extend beyond the height of the pouch.
Embodiment 10: The method of any previous embodiment, wherein trimming the enclosure comprises trimming the enclosure by die cutting, rotary cutting, reciprocal cutting, laser cutting, fluid jet cutting, or any combination thereof
Embodiment 11: The method of any previous embodiment, wherein the enclosure comprises aluminum, an aluminum alloy, a polymer, a thin film flexible metal, or any combination thereof.
Embodiment 12: A method of forming a lithium containing secondary battery positioned within a pouch defined by an enclosure, wherein the lithium containing battery includes a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure, wherein the enclosure includes a plurality of flaps extending outward from the pouch, the plurality of flaps including a first side flap extending from the pouch at a first fold line, a second side flap extending from the pouch at a second fold line, and an end flap extending from the pouch at a third fold line, the method comprising applying a bonding agent to at least one of the first side flap and the pouch, to at least one of the second side flap and the pouch, and to at least one of the end flap and the pouch, folding the first side flap about the first fold line towards the pouch, wherein a portion of the first side flap extends beyond the pouch to define a first tab, folding the second side flap about the second fold line towards the pouch, wherein a portion of the second side flap extends beyond the pouch to define a second tab, compressing the first and second side flaps against the pouch, folding the end flap about the third fold line towards and into contact with the pouch, applying, after the end flap is folded into contact with the pouch, a bonding agent to at least one of the end flap and each of the first and second tabs, folding the first tab and the second tab towards and into contact with the end flap to connect the first and second tabs to the end flap, and compressing the end flap, the first tab, and the second tab against the pouch.
Embodiment 13: The method of embodiment 12, wherein the enclosure includes a first enclosure layer and a second enclosure layer joined to the first enclosure layer, and wherein each flap includes a first surface defined by the first enclosure layer and an opposing second surface defined by the second enclosure layer.
Embodiment 14: The method of embodiment 13, wherein applying a bonding agent to at least one of the first side flap and the pouch, to at least one of the second side flap and the pouch, and to at least one of the end flap and the pouch comprises applying the bonding agent to at least one of the first surface of the first side flap and the pouch, to at least one of the first surface of the second side flap and the pouch, and to at least one of the first surface of the end flap and the pouch, and wherein compressing the first and second side flaps against the pouch comprises compressing the first surface of the first side flap and the first surface of the second side flap against the pouch.
Embodiment 15: The method of embodiment 14, wherein folding the end flap about the third fold line towards and into contact with the pouch comprises folding the end flap such that the first surface of the end flap contacts the pouch, wherein applying a bonding agent to at least one of the end flap and each of the first and second tabs comprises applying the bonding agent to at least one of the second surface of the end flap and each of the first and second tabs, and wherein folding the first tab and the second tab towards and into contact with the end flap comprises folding the first tab and the second tab towards and into contact with the second surface of the end flap.
Embodiment 16: The method of any previous embodiment, wherein each flap of the plurality of flaps has a width, measured from the respective fold line to a free edge of the flap, less than or equal to a height of the pouch such that when each of the plurality of flaps is folded into contact with the pouch, none of the plurality of flaps extend beyond the height of the pouch.
Embodiment 17: The method of any previous embodiment, wherein compressing the first and second side flaps against the pouch comprises compressing the first and second side flaps against the pouch while heated at a first temperature for a first compression time.
Embodiment 18: The method of embodiment 17, wherein the first compression time is between 10 seconds and 60 seconds, between 10 seconds and 40 seconds, between 20 seconds and 50 seconds, between 30 seconds and 60 seconds, between 10 seconds and 30 seconds, between 15 seconds and 35 seconds, between 20 seconds and 40 seconds, or between 25 seconds and 45 seconds.
Embodiment 19: The method of embodiment 17, wherein the first temperature is in a range of 50° C. to 150° C., in a range of 70° C. to 150° C., in a range of 90° C. to 150° C., in a range of 90° C. to 140° C., in a range of 100° C. to 150° C., in a range of 90° C. to 130° C., in a range of 100° C. to 140° C., in a range of 110° C. to 150° C., in a range of 90° C. to 120° C., in a range of 100° C. to 130° C., in a range of 110° C. to 140° C., or in a range of 120° C. to 150° C.
Embodiment 20: The method of any previous embodiment, wherein compressing the end flap, the first tab, and the second tab against the pouch comprises compressing the end flap, the first tab, and the second tab against the pouch while heated at a second temperature for a second compression time.
Embodiment 21: The method of embodiment 20, wherein the second compression time is between 10 seconds and 60 seconds, between 10 seconds and 40 seconds, between 20 seconds and 50 seconds, between 30 seconds and 60 seconds, between 10 seconds and 30 seconds, between 15 seconds and 35 seconds, between 20 seconds and 40 seconds, or between 25 seconds and 45 seconds.
Embodiment 22: The method of embodiment 20, wherein the second temperature is in a range of 50° C. to 150° C., in a range of 70° C. to 150° C., in a range of 90° C. to 150° C., in a range of 90° C. to 140° C., in a range of 100° C. to 150° C., in a range of 90° C. to 130° C., in a range of 100° C. to 140° C., in a range of 110° C. to 150° C., in a range of 90° C. to 120° C., in a range of 100° C. to 130° C., in a range of 110° C. to 140° C., or in a range of 120° C. to 150° C.
Embodiment 23: The method of any previous embodiment, wherein the bonding agent comprises adhesive tape.
Embodiment 24: The method of any previous embodiment, wherein the enclosure comprises aluminum, an aluminum alloy, a polymer, a thin film flexible metal, or any combination thereof.
Embodiment 25: A method of forming a lithium containing secondary battery including a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure, the method comprising positioning the lithium containing secondary battery within a pouch defined by an enclosure, positioning an auxiliary electrode within the pouch such that the auxiliary electrode is in contact with the lithium containing secondary battery, performing a buffer process on the lithium containing secondary battery whereby carrier ions from the auxiliary electrode are transferred to the lithium containing secondary battery, removing the auxiliary electrode from the pouch after the buffer process, sealing the enclosure with the secondary battery positioned within the pouch after the auxiliary electrode is removed from the pouch, trimming the sealed enclosure to form a plurality of flaps in the enclosure, wherein each flap extends outward from the pouch at a respective fold line, the plurality of flaps including a first side flap, a second side flap, and an end flap, attaching the first and second side flaps to the pouch by folding each of the first and second side flaps towards and into contact with the pouch, wherein a portion of the first side flap extends beyond the pouch to define a first tab, and a portion of the second side flap extends beyond the pouch to define a second tab, attaching the end flap to the pouch by folding the end flap towards and into contact with the pouch, and attaching the first tab and the second tab to the end flap by folding each of the first tab and the second tab towards and into contact with the end flap.
Embodiment 26: The method of embodiment 25, wherein: the enclosure includes a first enclosure layer and a second enclosure layer joined to the first enclosure layer, the pouch including a base defined by the first enclosure layer, a cover positioned opposite the base and defined by the second enclosure layer, a first sidewall extending from the base to the cover, a second sidewall positioned opposite the first sidewall and extending from the base to the cover, a first end wall extending from the first sidewall to the second sidewall and from the base to the cover, and a second end wall positioned opposite the first end wall and extending from the first sidewall to the second sidewall and from the base to the cover, wherein the first and second terminals of the secondary battery extend outward from the second end wall; each flap includes a first surface defined by the first enclosure layer and an opposing second surface defined by the second enclosure layer, the first side flap extending from the first sidewall of the pouch at a first fold line, the second side flap extending from the second sidewall of the pouch at a second fold line, and the end flap extending from the first end wall of the pouch at a third fold line; attaching the first and second side flaps to the pouch includes: applying a bonding agent to at least one of the first surface of the first side flap and the pouch first sidewall, to at least one of the first surface of the second side flap and the pouch second sidewall, and to at least one of the first surface of the end flap and the first end wall; folding the first side flap about the first fold line towards and into contact with the pouch first sidewall, wherein the portion of the first side flap extends beyond the pouch first end wall to define the first tab; folding the second side flap about the second fold line towards and into contact with the pouch second sidewall, wherein the portion of the second side flap extends beyond the pouch first end wall to define the second tab; and compressing the first side flap against the pouch first sidewall and the second side flap against the pouch second sidewall while heated at a first temperature for a first compression time; and attaching the end flap to the pouch and the first tab and the second tab to the end cap includes: folding the end flap about the third fold line towards and into contact with the pouch first end wall; applying, after the end flap is folded into contact with the pouch first end wall, a bonding agent to at least one of the second surface of the end flap and the first surface of each of the first and second tabs; folding the first tab about a fourth fold line towards and into contact with the second surface of the end flap; folding the second tab about a fifth fold line towards and into contact with the second surface of the end flap; and compressing the end flap, the first tab, and the second tab against the pouch first end wall while heated at a second temperature for a second compression time.
Embodiment 27: A method of forming a lithium containing secondary battery including a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure, the method comprising positioning the lithium containing secondary battery within a pouch defined by an enclosure, wherein the enclosure includes a first enclosure layer and a second enclosure layer joined to the first enclosure layer, the pouch including a base defined by the first enclosure layer, a cover positioned opposite the base and defined by the second enclosure layer, a first sidewall extending from the base to the cover, a second sidewall positioned opposite the first sidewall and extending from the base to the cover, a first end wall extending from the first sidewall to the second sidewall and from the base to the cover, and a second end wall positioned opposite the first end wall and extending from the first sidewall to the second sidewall and from the base to the cover, wherein the first and second terminals of the secondary battery extend outward from the second end wall, trimming the enclosure to form a plurality of flaps in the enclosure, wherein each flap extends outward from the pouch at a respective fold line and includes a first surface defined by the first enclosure layer and an opposing second surface defined by the second enclosure layer, the plurality of flaps including a first side flap extending from the first sidewall of the pouch at a first fold line, a second side flap extending from the second sidewall of the pouch at a second fold line, and an end flap extending from the first end wall of the pouch at a third fold line, applying a bonding agent to at least one of the first surface of the first side flap and the pouch first sidewall, to at least one of the first surface of the second side flap and the pouch second sidewall, and to at least one of the first surface of the end flap and the first end wall, folding the first side flap about the first fold line towards and into contact with the pouch first sidewall, wherein a portion of the first side flap extends beyond the pouch first end wall to define a first tab, folding the second side flap about the second fold line towards and into contact with the pouch second sidewall, wherein a portion of the second side flap extends beyond the pouch first end wall to define a second tab, compressing the first side flap against the pouch first sidewall and the second side flap against the pouch second sidewall while heated at a first temperature for a first compression time, folding the end flap about the third fold line towards and into contact with the pouch first end wall, applying, after the end flap is folded into contact with the pouch first end wall, a bonding agent to at least one of the second surface of the end flap and the first surface of each of the first and second tabs, folding the first tab about a fourth fold line towards and into contact with the second surface of the end flap, folding the second tab about a fifth fold line towards and into contact with the second surface of the end flap, and compressing the end flap, the first tab, and the second tab against the pouch first end wall while heated at a second temperature for a second compression time.
Embodiment 28: The method of embodiment 26 or embodiment 27, wherein trimming the enclosure comprises trimming the enclosure such that each flap of the plurality of flaps has a width, measured from the respective fold line to a free edge of the flap, less than or equal to a height of the pouch such that when each of the plurality of flaps is folded into contact with the pouch, none of the plurality of flaps extend beyond the height of the pouch.
Embodiment 29: The method of any previous embodiment, wherein compressing the first side flap against the pouch first sidewall and the second side flap against the pouch second sidewall comprises applying a compressive force across the pouch first sidewall and the pouch second sidewall equal to a pressure of at least 5 pounds per square inch (psi), at least 8 psi, at least 10 psi, at least 15 psi, at least 20 psi, at least 25 psi, at least 30 psi, at least 35 psi, between 5 psi and 50 psi, between 5 psi and 20 psi, between 10 psi and 40 psi, between 5 psi and 15 psi, or between 20 psi and 40 psi.
Embodiment 30: The method of any previous embodiment, wherein the first compression time is between 10 seconds and 60 seconds, between 10 seconds and 40 seconds, between 20 seconds and 50 seconds, between 30 seconds and 60 seconds, between 10 seconds and 30 seconds, between 15 seconds and 35 seconds, between 20 seconds and 40 seconds, or between 25 seconds and 45 seconds.
Embodiment 31: The method of any previous embodiment, wherein the first temperature is in a range of 50° C. to 150° C., in a range of 70° C. to 150° C., in a range of 90° C. to 150° C., in a range of 90° C. to 140° C., in a range of 100° C. to 150° C., in a range of 90° C. to 130° C., in a range of 100° C. to 140° C., in a range of 110° C. to 150° C., in a range of 90° C. to 120° C., in a range of 100° C. to 130° C., in a range of 110° C. to 140° C., or in a range of 120° C. to 150° C.
Embodiment 32: The method of any previous embodiment, wherein compressing the end flap, the first tab, and the second tab against the pouch first end wall comprises applying a compressive force across the pouch first end wall equal to a pressure of at least 3 pounds per square inch (psi), at least 4 psi, at least 5 psi, at least 10 psi, at least 15 psi, at least 20 psi, between 3 psi and 40 psi, between 3 psi and 30 psi, between 3 psi and 25 psi, between 4 psi and 40 psi, between 4 psi and 25 psi, between 5 psi and 40 psi, between 5 psi and 30 psi, between 5 psi and 25 psi, between 10 psi and 50 psi, between 10 psi and 40 psi, between 10 psi and 30 psi, between 10 psi and 25 psi, between 15 psi and 30 psi, or between 20 psi and 35 psi.
Embodiment 33: The method of any previous embodiment, wherein the second compression time is between 10 seconds and 60 seconds, between 10 seconds and 40 seconds, between 20 seconds and 50 seconds, between 30 seconds and 60 seconds, between 10 seconds and 30 seconds, between 15 seconds and 35 seconds, between 20 seconds and 40 seconds, or between 25 seconds and 45 seconds.
Embodiment 34: The method of any previous embodiment, wherein the second temperature is in a range of 50° C. to 150° C., in a range of 70° C. to 150° C., in a range of 90° C. to 150° C., in a range of 90° C. to 140° C., in a range of 100° C. to 150° C., in a range of 90° C. to 130° C., in a range of 100° C. to 140° C., in a range of 110° C. to 150° C., in a range of 90° C. to 120° C., in a range of 100° C. to 130° C., in a range of 110° C. to 140° C., or in a range of 120° C. to 150° C.
Embodiment 35: A secondary battery assembly formed using any of the previous embodiments of the methods of forming lithium containing secondary batteries.
Embodiment 36: The secondary battery assembly of embodiment 35, wherein an electrode assembly of the battery assembly comprises a rectangular prismatic shape.
Embodiment 37: The secondary battery assembly of any prior embodiment, wherein the electrode assembly is enclosed within a volume defined by a constraint.
Embodiment 38: The secondary battery assembly of any prior embodiment, wherein the electrode assembly comprises an anodically active material selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) alloys or intermetallic compounds of Si, Ge, Sn, Pb, Sb, Bi, Zn, Al, Ti, Ni, Co, or Cd with other elements; (c) oxides, carbides, nitrides, sulfides, phosphides, selenides, and tellurides of Si, Ge, Sn, Pb, Sb, Bi, Zn, Al, Ti, Fe, Ni, Co, V, or Cd, and their mixtures, composites, or lithium-containing composites; (d) salts and hydroxides of Sn; (e) lithium titanate, lithium manganate, lithium aluminate, lithium-containing titanium oxide, lithium transition metal oxide, ZnCo₂O₄; (f) particles of graphite and carbon; (g) lithium metal; and (h) combinations thereof.
Embodiment 39: The secondary battery assembly of any prior embodiment, wherein the electrode assembly comprises an anodically active material selected from the group consisting of silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd).
Embodiment 40: The secondary battery assembly of any prior embodiment, wherein the electrode assembly comprises an anodically active material selected from the group consisting of alloys and intermetallic compounds of Si, Ge, Sn, Pb, Sb, Bi, Zn, Al, Ti, Ni, Co, or Cd with other elements.
Embodiment 41: The secondary battery assembly of any prior embodiment, wherein the electrode assembly comprises an anodically active material selected from the group consisting of oxides, carbides, nitrides, sulfides, phosphides, selenides, and tellurides of Si, Ge, Sn, Pb, Sb, Bi, Zn, Al, Ti, Fe, Ni, Co, V, and Cd.
Embodiment 42: The secondary battery assembly of any prior embodiment, wherein the electrode assembly comprises an anodically active material selected from the group consisting of oxides, carbides, nitrides, sulfides, phosphides, selenides, and tellurides of Si.
Embodiment 43: The secondary battery assembly of any prior embodiment, wherein the electrode assembly comprises an anodically active material selected from the group consisting of silicon and the oxides and carbides of silicon.
Embodiment 44: The secondary battery assembly of any prior embodiment, wherein the electrode assembly comprises an anodically active material comprising lithium metal.
Embodiment 45: The secondary battery assembly of any prior embodiment, wherein the electrode assembly comprises an anodically active material selected from the group consisting of graphite and carbon.
Embodiment 46: The secondary battery assembly of any prior embodiment, wherein within the enclosure the secondary battery further comprises a non-aqueous, organic electrolyte.
Embodiment 47: The secondary battery assembly of any prior embodiment, wherein within the enclosure the secondary battery further comprises a non-aqueous electrolyte comprising a mixture of a lithium salt and an organic solvent.
Embodiment 48: The secondary battery assembly of any prior embodiment, wherein within the enclosure the secondary battery further comprises a polymer electrolyte.
Embodiment 49: The secondary battery assembly of any prior embodiment, wherein within the enclosure the secondary battery further comprises a solid electrolyte.
Embodiment 50: The secondary battery assembly of any prior embodiment, wherein within the enclosure the secondary battery further comprises a solid electrolyte selected from the group consisting of sulfide-based electrolytes.
Embodiment 51: The secondary battery assembly of any prior embodiment, wherein within the enclosure the secondary battery further comprises a solid electrolyte selected from the group consisting of lithium tin phosphorus sulfide (Li₁₀SnP₂S₁₂), lithium phosphorus sulfide (β-Li₃PS₄) and lithium phosphorus sulfur chloride iodide (Li₆PS₅Cl_{0.9}I_{0.1}).
Embodiment 52: The secondary battery assembly of any prior embodiment, wherein within the enclosure the secondary battery further comprises a polymer-based electrolyte.
Embodiment 53: The secondary battery assembly of any prior embodiment, wherein within the enclosure the secondary battery further comprises a polymer electrolyte selected from the group consisting of PEO-based polymer electrolyte, polymer-ceramic composite electrolyte (solid), and other polymer-ceramic composite electrolytes.
Embodiment 54: The secondary battery assembly of any prior embodiment, wherein within the enclosure the secondary battery further comprises a solid electrolyte selected from the group consisting of oxide-based electrolytes.
Embodiment 55: The secondary battery assembly of any prior embodiment, wherein within the enclosure the secondary battery further comprises a solid electrolyte selected from the group consisting of lithium lanthanum titanate (Li_{0.34}La_{0.56}TiO₃), Al-doped lithium lanthanum zirconate (Li_{6.24}La₃Zr₂Al_{0.24}O_{11.98}), Ta-doped lithium lanthanum zirconate (Li_{6.4}La₃Zr_{1.4}Ta_{0.6}O₁₂) and lithium aluminum titanium phosphate (Li_{1.4}Al_{0.4}Ti_{1.6}(PO₄)₃).
Embodiment 56: The secondary battery assembly of any prior embodiment, wherein one of electrode active material and counter-electrode material of the electrode assembly is a cathodically active material selected from the group consisting of intercalation chemistry positive electrodes and conversion chemistry positive electrodes.
Embodiment 57: The secondary battery assembly of any prior embodiment, wherein one of electrode active material and counter-electrode material of the electrode assembly is a cathodically active material comprising an intercalation chemistry positive electrode material.
Embodiment 58: The secondary battery assembly of any prior embodiment, wherein one of electrode active material and counter-electrode material of the electrode assembly is a cathodically active material comprising a conversion chemistry positive electrode active material.
Embodiment 59: The secondary battery assembly of any prior embodiment, wherein one of electrode active material and counter-electrode material of the electrode assembly is a cathodically active material selected from the group consisting of S (or Li₂S in the lithiated state), LiF, Fe, Cu, Ni, FeF₂, FeO_{d}F_{3.2d}, FeF₃, CoF₃, CoF₂, CuF₂, NiF₂, where 0≤d≤0.5.
Embodiment 60: The secondary battery assembly of any prior embodiment, wherein the electrode structure is one of a positive electrode and a negative electrode, the counter-electrode structure is the other one of the positive electrode and the negative electrode, the positive electrode has a positive electrode coulombic capacity, and the negative electrode has a negative electrode coulombic capacity exceeding the positive electrode coulombic capacity.
Embodiment 61: The secondary battery assembly of embodiment 60, wherein a ratio of the negative electrode coulombic capacity to the positive electrode coulombic capacity is at least 1.2:1.
Embodiment 62: The secondary battery assembly of embodiment 60, wherein a ratio of the negative electrode coulombic capacity to the positive electrode coulombic capacity is at least 1.3:1.
Embodiment 63: The secondary battery assembly of embodiment 60, wherein a ratio of the negative electrode coulombic capacity to the positive electrode coulombic capacity is at least 1.5:1.
Embodiment 64: The secondary battery assembly of embodiment 60, wherein a ratio of the negative electrode coulombic capacity to the positive electrode coulombic capacity is at least 2:1.
Embodiment 65: The secondary battery assembly of embodiment 60, wherein a ratio of the negative electrode coulombic capacity to the positive electrode coulombic capacity is at least 3:1.
Embodiment 66: The secondary battery assembly of embodiment 60, wherein a ratio of the negative electrode coulombic capacity to the positive electrode coulombic capacity is at least 4:1.
Embodiment 67: The secondary battery assembly of embodiment 60, wherein a ratio of the negative electrode coulombic capacity to the positive electrode coulombic capacity is at least 5:1.
Embodiment 68: The method of any previous embodiment, further comprising positioning the lithium containing secondary battery within the pouch defined by the enclosure, positioning an auxiliary electrode within the pouch such that the auxiliary electrode is in contact with the lithium containing secondary battery, and performing a buffer process on the lithium containing secondary battery whereby carrier ions from the auxiliary electrode are transferred to the lithium containing secondary battery.
Embodiment 69: The method of embodiment 68, further comprising removing the auxiliary electrode from the pouch after the buffer process, and sealing the enclosure with the secondary battery positioned within the pouch after the auxiliary electrode is removed from the pouch.
Embodiment 70: The method of embodiment 68 or embodiment 69, wherein the auxiliary electrode includes a first separator layer including an ionically permeable material, a conductive layer including an electrically conductive material, the conductive layer having a first surface contacting the first separator layer and a second surface opposing the first surface, a population of carrier ion supply layers disposed on the second surface of the conductive layer, each carrier ion supply layer including a material that supplies lithium ions for the electrode active material layers of the lithium containing secondary battery, and a second separator layer including an ionically permeable material and in contact with the carrier ion supply layers.
Embodiment 71: The method of embodiment 70, wherein the second surface of the conductive layer includes a first region disposed at a first end of the conductive layer, a second region disposed at a second end of the conductive layer that opposes the first end, and a third region disposed between the first region and the second region, wherein one of the carrier ion supply layers is disposed within the first region and another one of carrier ion supply layer is disposed within the second region.
Embodiment 72: The method of embodiment 71, wherein the second separator layer is in contact with the third region of the second surface of the conductive layer.
Embodiment 73: The method of embodiment 70 or embodiment 71, wherein the first region, the second region, and the third region are disposed across a length of the conductive layer.
Embodiment 74: The method of any one of embodiments 70-73, wherein the first separator layer and the second separator layer are mechanically bonded together around at least a portion of a perimeter of the first separator layer and the second separator layer.
Embodiment 75: The method of any one of embodiments 70-74, wherein the first separator layer and the second separator layer are formed from a continuous separator material, the first separator layer includes a first portion of the continuous separator material, the second separator layer includes a second portion of the continuous separator material, and the second portion is folded over the first portion to contact surfaces of the carrier ion supply layers.
Embodiment 76: The method of embodiment 75, wherein the continuous separator material has a thickness in a range of about 0.01 millimeter to about 1 millimeter.
Embodiment 77: The method of embodiment 76, wherein the thickness of the continuous separator material is about 0.025 millimeter.
Embodiment 78: The method of any one of embodiments 70-77, wherein the first separator layer and the second separator layer have a thickness in a range of values of about 0.01 millimeter to about 1 millimeter.
Embodiment 79: The method of any one of embodiments 70-78, wherein a thickness of the second separator layer is about 0.025 millimeter.
Embodiment 80: The method of any one of embodiments 70-79, wherein the conductive layer includes one of copper and aluminum, or alloys of copper and aluminum.
Embodiment 81: The method of any one of embodiments 70-80, wherein the conductive layer includes copper.
Embodiment 82: The method of any one of embodiments 70-81, wherein the conductive layer has a thickness in a range of values of about 0.01 millimeter to about 1 millimeter.
Embodiment 83: The method of any one of embodiments 70-82, wherein the conductive layer has a thickness of about 0.1 millimeter.
Embodiment 84: The method of any one of embodiments 70-83, wherein the carrier ion supply layers have a thickness in a range of values of about 0.05 millimeter to about 1 millimeter.
Embodiment 85: The method of any one of embodiments 70-84, wherein the carrier ion supply layers have a thickness of about 0.15 millimeter.
Embodiment 86: The method of any one of embodiments 70-85, wherein the carrier ion supply layers provide a source of lithium ions.
Embodiment 87: The method of any one of embodiments 70-86, wherein the carrier ion supply layers are cold welded to the second surface of the conductive layer.
Embodiment 88: The method of any one of embodiments 70-87, wherein the auxiliary electrode includes a conductive tab including an electrically conductive material and coupled to the second surface of the conductive layer.
Embodiment 89: The method of any one of embodiments 88, wherein the conductive tab includes a first end that is coupled to the conductive layer and a second end distal to the first end that projects away from the conductive layer.
Embodiment 90: The method of any one of embodiment 88 or embodiment 89, wherein the conductive tab includes one of nickel, copper, and aluminum, or alloys of copper, nickel, and aluminum.
Embodiment 91: The method of any one of embodiment 88 or embodiment 89, wherein the conductive tab includes nickel.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of forming a lithium containing secondary battery including a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure, the method comprising:
positioning the lithium containing secondary battery within a pouch defined by an enclosure;
trimming the enclosure to form a plurality of flaps, the plurality of flaps including a first side flap extending from the pouch at a first fold line, a second side flap extending from the pouch at a second fold line, and an end flap extending from the pouch at a third fold line;
attaching the first side flap and the second side flap to the pouch by folding each of the first and second side flaps about the respective first and second fold lines towards and into contact with the pouch, wherein a portion of the first side flap extends beyond the pouch to define a first tab and a portion of the second side flap extends beyond the pouch to define a second tab;
attaching the end flap to the pouch by folding the end flap about the third fold line towards and into contact with the pouch; and
attaching the first tab and the second tab to the end flap by folding each of the first tab and the second tab towards and into contact with the end flap.

2. The method of claim 1, wherein attaching the first side flap and the second side flap to the pouch comprises:
applying a bonding agent to at least one of the first side flap and the pouch, and to at least one of the second side flap and the pouch;
folding the first side flap about the first fold line towards the pouch;
folding the second side flap about the second fold line towards the pouch; and
compressing the first and second side flaps against the pouch.

3. The method of claim 2, wherein compressing the first and second side flaps against the pouch comprises compressing the first and second side flaps against the pouch while heated at a temperature in a range of 50° C. to 150° C.

4. The method of claim 3, wherein compressing the first and second side flaps against the pouch comprises compressing the first and second side flaps against the pouch while heated at the temperature for a time in a range of 10 seconds to 60 seconds.

5. The method of claim 1, wherein attaching the end flap to the pouch comprises:
applying a bonding agent to at least one of the end flap and the pouch;
folding the end flap about the third fold line towards the pouch; and
compressing the end flap, the first tab, and the second tab against the pouch after the first tab and the second tab are folded towards and into contact with the end flap.

6. The method of claim 1, wherein attaching the first tab and the second tab to the end flap comprises:
applying, after the end flap is folded towards and into contact with the pouch, a bonding agent to at least one of the end flap and each of the first and second tabs;
folding the first and second tabs towards and into contact with the end flap; and
compressing the end flap, the first tab, and the second tab against the pouch.

7. The method of claim 6, wherein compressing the end flap, the first tab, and the second tab against the pouch comprises compressing the end flap, the first tab, and the second tab against the pouch while heated at a temperature in a range of 50° C. to 150° C.

8. The method of claim 7, wherein compressing the end flap, the first tab, and the second tab against the pouch comprises compressing the end flap, the first tab, and the second tab against the pouch while heated at the temperature for a time in a range of 10 seconds to 60 seconds.

9. The method of claim 1, wherein trimming the enclosure comprises trimming the enclosure such that each flap of the plurality of flaps has a width, measured from the respective fold line to a free edge of the flap, less than or equal to a height of the pouch such that when each of the plurality of flaps is folded into contact with the pouch, none of the plurality of flaps extend beyond the height of the pouch.

10. The method of claim 1, wherein trimming the enclosure comprises trimming the enclosure by die cutting, rotary cutting, reciprocal cutting, laser cutting, fluid jet cutting, or any combination thereof.

11. The method of claim 1, wherein the enclosure comprises aluminum, an aluminum alloy, a polymer, a thin film flexible metal, or any combination thereof.

12. A method of forming a lithium containing secondary battery positioned within a pouch defined by an enclosure, wherein the lithium containing battery includes a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure, wherein the enclosure includes a plurality of flaps extending outward from the pouch, the plurality of flaps including a first side flap extending from the pouch at a first fold line, a second side flap extending from the pouch at a second fold line, and an end flap extending from the pouch at a third fold line, the method comprising:
applying a bonding agent to at least one of the first side flap and the pouch, to at least one of the second side flap and the pouch, and to at least one of the end flap and the pouch;
folding the first side flap about the first fold line towards the pouch, wherein a portion of the first side flap extends beyond the pouch to define a first tab;
folding the second side flap about the second fold line towards the pouch, wherein a portion of the second side flap extends beyond the pouch to define a second tab;
compressing the first and second side flaps against the pouch;
folding the end flap about the third fold line towards and into contact with the pouch;
applying, after the end flap is folded into contact with the pouch, a bonding agent to at least one of the end flap and each of the first and second tabs;
folding the first tab and the second tab towards and into contact with the end flap to connect the first and second tabs to the end flap; and
compressing the end flap, the first tab, and the second tab against the pouch.

13. The method of claim 12, wherein the enclosure includes a first enclosure layer and a second enclosure layer joined to the first enclosure layer, and wherein each flap includes a first surface defined by the first enclosure layer and an opposing second surface defined by the second enclosure layer.

14. The method of claim 13, wherein:
applying a bonding agent to at least one of the first side flap and the pouch, to at least one of the second side flap and the pouch, and to at least one of the end flap and the pouch comprises applying the bonding agent to at least one of the first surface of the first side flap and the pouch, to at least one of the first surface of the second side flap and the pouch, and to at least one of the first surface of the end flap and the pouch; and
compressing the first and second side flaps against the pouch comprises compressing the first surface of the first side flap and the first surface of the second side flap against the pouch.

15. The method of claim 14, wherein:
folding the end flap about the third fold line towards and into contact with the pouch comprises folding the end flap such that the first surface of the end flap contacts the pouch;
applying a bonding agent to at least one of the end flap and each of the first and second tabs comprises applying the bonding agent to at least one of the second surface of the end flap and each of the first and second tabs; and
folding the first tab and the second tab towards and into contact with the end flap comprises folding the first tab and the second tab towards and into contact with the second surface of the end flap.

16. The method of claim 12, wherein each flap of the plurality of flaps has a width, measured from the respective fold line to a free edge of the flap, less than or equal to a height of the pouch such that when each of the plurality of flaps is folded into contact with the pouch, none of the plurality of flaps extend beyond the height of the pouch.

17. The method of claim 12, wherein compressing the first and second side flaps against the pouch comprises compressing the first and second side flaps against the pouch while heated at a first temperature for a first compression time.

18. The method of claim 17, wherein the first compression time is between 10 seconds and 60 seconds.

19. The method of claim 17, wherein the first temperature is in a range of 50° C. to 150° C.

20. The method of claim 12, wherein compressing the end flap, the first tab, and the second tab against the pouch comprises compressing the end flap, the first tab, and the second tab against the pouch while heated at a second temperature for a second compression time.

21. The method of claim 20, wherein the second compression time is between 10 seconds and 60 seconds.

22. The method of claim 20, wherein the second temperature is in a range of 50° C. to 150° C.

23. The method of claim 12, wherein the bonding agent comprises adhesive tape.

24. The method of claim 12, wherein the enclosure comprises aluminum, an aluminum alloy, a polymer, a thin film flexible metal, or any combination thereof.

25. A method of forming a lithium containing secondary battery including a population of unit cells, an electrode busbar, a counter-electrode busbar, a first terminal electrically connected to the electrode busbar, and a second terminal electrically connected to the counter-electrode busbar, wherein each unit cell of the population of unit cells comprises an electrode structure, a separator structure, and a counter-electrode structure, the method comprising:
positioning the lithium containing secondary battery within a pouch defined by an enclosure;
positioning an auxiliary electrode within the pouch such that the auxiliary electrode is in contact with the lithium containing secondary battery;
performing a buffer process on the lithium containing secondary battery whereby carrier ions from the auxiliary electrode are transferred to the lithium containing secondary battery;
removing the auxiliary electrode from the pouch after the buffer process;
sealing the enclosure with the secondary battery positioned within the pouch after the auxiliary electrode is removed from the pouch;
trimming the sealed enclosure to form a plurality of flaps in the enclosure, wherein each flap extends outward from the pouch at a respective fold line, the plurality of flaps including a first side flap, a second side flap, and an end flap;
attaching the first and second side flaps to the pouch by folding each of the first and second side flaps towards and into contact with the pouch, wherein a portion of the first side flap extends beyond the pouch to define a first tab, and a portion of the second side flap extends beyond the pouch to define a second tab;
attaching the end flap to the pouch by folding the end flap towards and into contact with the pouch; and
attaching the first tab and the second tab to the end flap by folding each of the first tab and the second tab towards and into contact with the end flap.

26. The method of claim 25, wherein:
the enclosure includes a first enclosure layer and a second enclosure layer joined to the first enclosure layer, the pouch including a base defined by the first enclosure layer, a cover positioned opposite the base and defined by the second enclosure layer, a first sidewall extending from the base to the cover, a second sidewall positioned opposite the first sidewall and extending from the base to the cover, a first end wall extending from the first sidewall to the second sidewall and from the base to the cover, and a second end wall positioned opposite the first end wall and extending from the first sidewall to the second sidewall and from the base to the cover, wherein the first and second terminals of the secondary battery extend outward from the second end wall;
each flap includes a first surface defined by the first enclosure layer and an opposing second surface defined by the second enclosure layer, the first side flap extending from the first sidewall of the pouch at a first fold line, the second side flap extending from the second sidewall of the pouch at a second fold line, and the end flap extending from the first end wall of the pouch at a third fold line;
attaching the first and second side flaps to the pouch comprises:
applying a bonding agent to at least one of the first surface of the first side flap and the pouch first sidewall, to at least one of the first surface of the second side flap and the pouch second sidewall, and to at least one of the first surface of the end flap and the first end wall;
folding the first side flap about the first fold line towards and into contact with the pouch first sidewall, wherein the portion of the first side flap extends beyond the pouch first end wall to define the first tab;
folding the second side flap about the second fold line towards and into contact with the pouch second sidewall, wherein the portion of the second side flap extends beyond the pouch first end wall to define the second tab; and
compressing the first side flap against the pouch first sidewall and the second side flap against the pouch second sidewall while heated at a first temperature for a first compression time; and
attaching the end flap to the pouch and the first tab and the second tab to the end flap comprises:
folding the end flap about the third fold line towards and into contact with the pouch first end wall;
applying, after the end flap is folded into contact with the pouch first end wall, a bonding agent to at least one of the second surface of the end flap and the first surface of each of the first and second tabs;
folding the first tab about a fourth fold line towards and into contact with the second surface of the end flap;
folding the second tab about a fifth fold line towards and into contact with the second surface of the end flap; and
compressing the end flap, the first tab, and the second tab against the pouch first end wall while heated at a second temperature for a second compression time.

27. The method of claim 26, wherein trimming the enclosure comprises trimming the enclosure such that each flap of the plurality of flaps has a width, measured from the respective fold line to a free edge of the flap, less than or equal to a height of the pouch such that when each of the plurality of flaps is folded into contact with the pouch, none of the plurality of flaps extend beyond the height of the pouch.

28. The method of claim 26, wherein compressing the first side flap against the pouch first sidewall and the second side flap against the pouch second sidewall comprises applying a compressive force across the pouch first sidewall and the pouch second sidewall equal to a pressure of at least 5 pounds per square inch.

29. The method of claim 26, wherein the first compression time is between 10 seconds and 60 seconds.

30. The method of claim 26, wherein the first temperature is in a range of 50° C. to 150° C.

31. The method of claim 26, wherein compressing the end flap, the first tab, and the second tab against the pouch first end wall comprises applying a compressive force across the pouch first end wall equal to a pressure of at least 3 pounds per square inch.

32. The method of claim 26, wherein the second compression time is between 10 seconds and 60 seconds.

33. The method of claim 26, wherein the second temperature is in a range of 50° C. to 150° C.
